(19) United States
(12) Patent Application Publication
(10) Pub. No.: US 2023/0092168 A1
(43) Pub. Date: Mar. 23, 2023

(54) INFORMATION PROCESSING DEVICE, INFORMATION PROCESSING TERMINAL, AND INFORMATION PROCESSING METHOD

(71) Applicant: SONY GROUP CORPORATION, Tokyo (JP)

(72) Inventors: Mari IKENAGA, Tokyo (JP); Kazunori YAMAMOTO, Tokyo (JP); Kotoko YAMAGUCHI, Kanagawa (JP)

(73) Assignee: SONY GROUP CORPORATION, Tokyo (JP)

(21) Appl. No.: 17/801,991

(22) PCT Filed: Mar. 22, 2021
(86) PCT No.: PCT/JP2021/011573

§ 371 Date: Aug. 24, 2022

(30) Foreign Application Priority Data
Mar. 30, 2020 (JP) 2020-060597

(51) Int. Cl. A47J 44/00; B25J 13/00

(52) U.S. Cl. CPC A47J 44/00; B25J 13/00

(57) ABSTRACT

There is provided an information processing device, an information processing terminal, and an information processing method capable of efficiently developing a recipe program to be used by a cooking robot. The processing device according to an aspect of the present technology provides a recipe program generated by combining, according to a dish, program modules prepared for each of cooking steps or for each unit of operations included in each of the cooking steps. The present technology is applicable to a server which discloses a recipe program to be used for controlling a cooking robot.

### TECHNICAL FIELD

The present technology particularly relates to an information processing device, an information processing terminal, and an information processing method capable of efficiently developing a recipe program to be used by a cooking robot.

### BACKGROUND ART

Cooking robots which automatically perform cooking by driving robot arms are under development in recent years. For example, cooking operations using robot arms are carried out under programs created to reproduce movement identical to movement of hands of a cook.

### CITATION LIST

### Patent Literature

[PTL 1] Japanese Patent Laid-open No. 2019-201338
[PTL 2] Japanese Patent Laid-open No. Hei 02-105993
[PTL 3] Japanese Patent Laid-open No. 2003-323487

### SUMMARY

### Technical Problems

Individual programs for achieving various operations are needed to develop a program for controlling all operations to be performed to complete one dish. For example, it is necessary to equip a program for recognizing ingredients and a cooking device to be used for each step, a program for recognizing the degree of grilling or a size of an ingredient in each of cooking steps, a program for controlling operations of a robot arm, such as cutting, holding, moving, and mixing, or other programs.

It is difficult for a developer to create entire programs for completing one dish from the beginning.

Moreover, such difficulty further causes a difficulty in increasing the types of programs, making it also difficult to achieve activation of an ecosystem mainly attained by a cooking robot. For example, cooking robots are expected to come into widespread use if the types of programs for cooking are increased. In this case, the number of persons who attempt to develop programs may increase. As obvious from this example, a system achieved mainly by a cooking robot is expected to be activated as what is generally called an ecosystem.

The present technology has been developed in consideration of the abovementioned circumstances, and achieves efficient development of a recipe program to be used by a cooking robot.

### Solution to Problems

An information processing device according to one aspect of the present technology includes an acquisition unit that acquires a recipe program generated by combining, according to a dish, program modules prepared for each of cooking steps or for each unit of operations included in each of the cooking steps, and a providing unit that provides the recipe program to a control device that controls cooking performed by a cooking robot.

An information processing terminal according to a different aspect of the present technology includes an acquisition unit that acquires any of program modules prepared for each of cooking steps or for each unit of operations included in each of the cooking steps, according to a dish, from a server that manages the program modules, and a generation unit that generates a recipe program to be provided to a control device that controls cooking of a cooking robot by combining the program modules acquired from the server.

According to the one aspect of the present technology, a recipe program generated by combining, according to a dish, program modules prepared for each of cooking steps or for each unit of operations included in each of the cooking steps is acquired. The recipe program for a control device that controls cooking performed by a cooking robot is provided.

According to the different aspect of the present technology, any of program modules prepared for each of cooking steps or for each unit of operations included in each of the cooking steps, according to a dish, is acquired from a server that manages the program modules. A recipe program provided to a control device that controls cooking of a cooking robot is generated by combining the program modules acquired from the server.

### BRIEF DESCRIPTION OF DRAWINGS

FIG. 1 is a diagram depicting a configuration example of a recipe program distribution system according to an embodiment of the present technology.

FIG. 2 is a diagram depicting an example of provision of a recipe program.

FIG. 3 is a diagram depicting a configuration example of an application library distribution server.

FIG. 4 is a diagram depicting a relation between respective modules.

FIG. 5 is a diagram depicting an example of development of control modules and recognition algorithm modules.

FIG. 6 is a diagram depicting an example of development of action modules.

FIG. 7 is a diagram depicting an example of development of cooking step modules.

FIG. 8 is a diagram depicting an example of development of recipe programs.

FIG. 9 is a diagram depicting an example of provision of recipe programs.

FIG. 10 is a diagram depicting a configuration example of recipe programs.

FIG. 11 is a diagram depicting a configuration example of a cooking step module.

FIG. 12 is a diagram depicting a configuration example of an action module.

FIG. 13 is a flowchart explaining a process of a cooking step of “chopping a potato.”

FIG. 14 is a flowchart explaining a process continuing from FIG. 13.

FIG. 15 is a flowchart explaining a process continuing from FIG. 14.

FIG. 16 is a flowchart explaining a process continuing from FIG. 15.

FIG. 17 is a flowchart explaining a process continuing from FIG. 16.

FIG. 18 is a diagram depicting an example of combinations of modules.

FIG. 19 is a diagram depicting an example of combinations of modules continuing from FIG. 18.

FIG. 20 is a block diagram depicting a configuration example of the application library distribution server.

FIG. 21 is a block diagram depicting a functional configuration example of the application library distribution server.

FIG. 22 is a block diagram depicting a functional configuration example of a developer terminal.

FIG. 23 is a diagram depicting a configuration example of a control system constituting a restaurant side.

FIG. 24 is a diagram depicting a flow of completion of a dish.

FIG. 25 is a diagram depicting a layout example of a control device.

FIG. 26 is a perspective diagram depicting an external appearance of a cooking robot.

FIG. 27 is a diagram of an enlarged illustration of a state of cooking arms.

FIG. 28 is a diagram depicting an external appearance of cooking arms.

FIG. 29 is a diagram depicting an example of movable ranges of respective portions of the cooking arm.

FIG. 30 is a diagram depicting an example of connection between the cooking arm and a controller.

FIG. 31 is a block diagram depicting a configuration example of the cooking robot.

FIG. 32 is a block diagram depicting a functional configuration example of the control device.

FIG. 33 is a flowchart explaining a process performed by the control device.

FIG. 34 is a flowchart explaining details of a cooking step process performed in step S4 in FIG. 33.

FIG. 35 is a flowchart explaining details of an action execution process performed in step S14 in FIG. 34.

FIG. 36 is a diagram depicting another configuration example of the control system.

FIG. 37 is a diagram depicting a flow of payment of a reward in the recipe program distribution system.

FIG. 38 is a diagram depicting an example of SDK.

FIG. 39 is a diagram depicting an example of a package including a recipe program.

### DESCRIPTION OF EMBODIMENTS

### «Outline of Present Technology»

The present technology divides a series of operations performed by a cooking robot for cooking into units of operations unique to cooking, such as cooking step units and action units, and defines a management method of a program module for each unit.

Program modules developed by respective developers are disclosed for other developers, and used as parts of recipe programs. Each recipe program developer is capable of developing recipe programs by combining and using the disclosed program modules in any manner according to each dish.

In such a manner, a threshold for entering the field of recipe program development is lowered, making it possible to achieve efficient development of recipe programs.

Moreover, operations of a cooking robot are modularized into units having high reusability to allow mass production of recipe programs. This makes it possible to achieve, as an ecosystem, activation of a recipe program distribution system achieved mainly by a cooking robot.

Modes for carrying out the present technology will hereinafter be described. The description will be presented in the following order.

1. First embodiment: recipe program distribution system

2. Second embodiment: mechanism for reward calculation

3. Others

### «1. First Embodiment: Recipe Program Distribution System»

### <System Configuration>

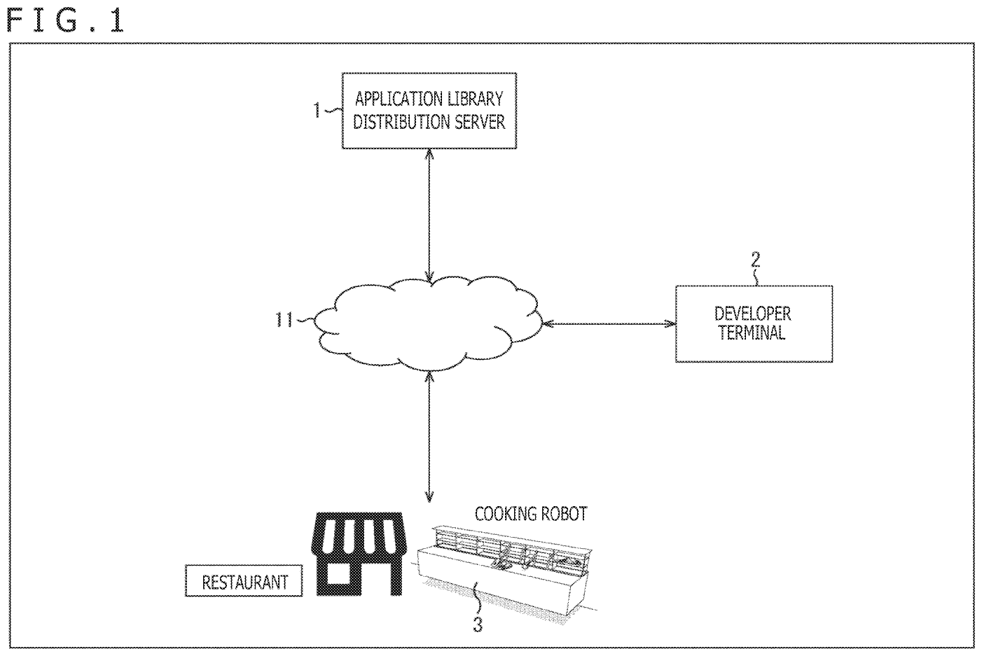

FIG. 1 is a diagram depicting a configuration example of a recipe program distribution system according to an embodiment of the present technology.

The recipe program distribution system illustrated in FIG. 1 is formed by a developer terminal 2 and a cooking robot 3 being connected to an application library distribution server 1 via a network 11 including the Internet or the like. The cooking robot 3 is installed at a place where dishes are offered, such as a restaurant. The cooking robot 3 may be installed at other places where cooking is performed, such as a place in a house or a food plant.

While FIG. 1 depicts only one developer terminal 2 by way of example, multiple developer terminals 2 are connected to the network 11. As for the cooking robot 3, multiple cooking robots 3 installed at respective places are similarly connected to the network 11.

The application library distribution server 1 manages recipe programs, and also manages development information used for developing recipe programs. The development information includes various types of information, such as modules (program modules) and SDK (Software Development Kit) used for development of recipe programs. Note that the library refers to a set of modules that enable achievement of specific functions.

Each of recipe programs is a program for controlling operations of the cooking robot 3. A recipe program is prepared for each dish to be made by the cooking robot 3. The cooking robot 3 is allowed to perform cooking operations by a recipe program being installed in the cooking robot 3 and executed. For example, one dish is completed when all cooking operations are finished under one recipe program.

Note that the dish refers to a deliverable completed through cooking. Cooking refers to a course of processes for making a dish, or an act (work) for making a dish.

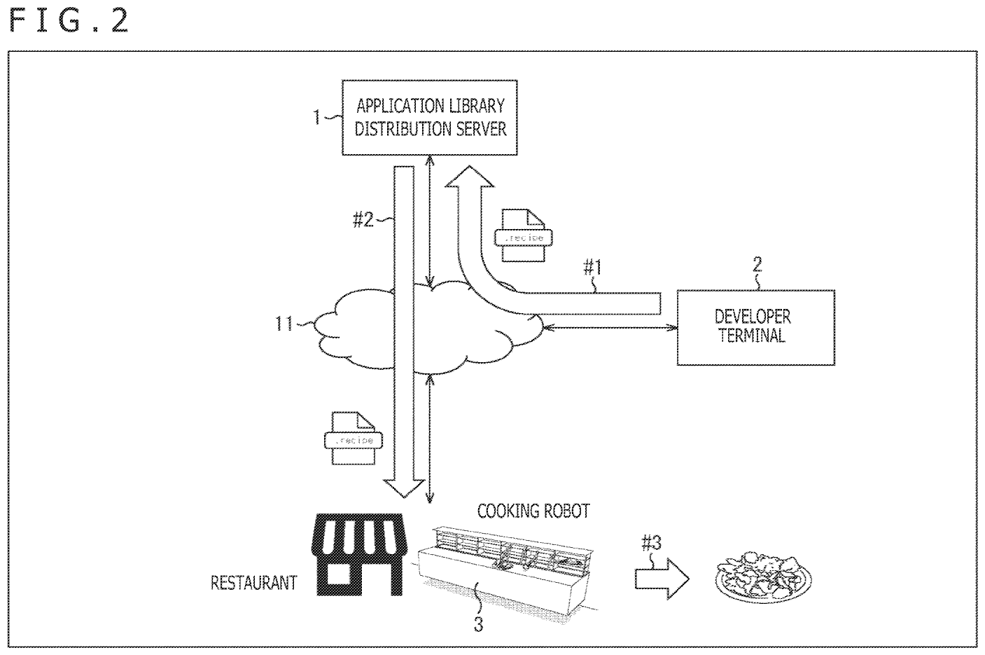

Each of recipe programs managed by the application library distribution server 1 is a program developed on the developer terminal 2 with use of the development information and provided to the application library distribution server 1 from the developer terminal 2 as indicated by an arrow #1 in FIG. 2. The application library distribution server 1 provides the development information to the developer terminal 2 in response to a request issued from a developer operating the developer terminal 2.

The recipe program provided from the developer terminal 2 and managed at the application library distribution server 1 is provided to the cooking robot 3 as indicated by an arrow #2 in FIG. 2 in response to a request from the cooking robot 3, for example.

A cooking operation is performed by the cooking robot 3 under the recipe program to make a dish and offer the dish to a guest of a restaurant as indicated by a destination of an arrow #3. As will be described below in detail, the cooking robot 3 is a robot that is equipped with devices of a driving system such as a cooking arm and various types of sensors and that has a function of performing cooking operations.

As described above, the application library distribution server 1 functions as an information processing device which provides information to be used for development of recipe programs to a developer and also discloses developed recipe programs and provides the recipe programs to the cooking robot 3.

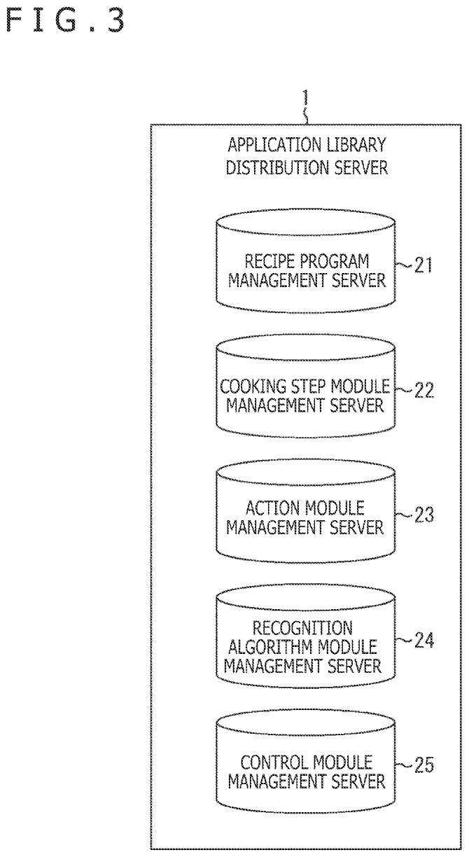

FIG. 3 is a diagram depicting a configuration example of the application library distribution server 1.

The application library distribution server 1 is configured as a server group including a recipe program management server 21, a cooking step module management server 22, an action module management server 23, a recognition algorithm module management server 24, and a control module management server 25.

The recipe program management server 21 manages recipe programs provided by the developer terminal 2. For example, a recipe program is transmitted from the developer terminal 2 to the application library distribution server 1 when the developer accesses a store site which is a web site managed by the recipe program management server 21 and performs an operation for registering the recipe program.

The recipe program management server 21 receives the recipe program transmitted from the developer terminal 2, and manages the recipe program in association with information indicating a developer or the like. For example, the recipe program management server 21 manages recipe programs of various dishes developed by multiple developers.

Moreover, the recipe program management server 21 provides a recipe program to the cooking robot 3 in response to a request issued from the cooking robot 3. For example, a recipe program is provided when a manager of the cooking robot 3 performs a predetermined operation for selecting a dish desired to be made, for example, on the store site.

The cooking step module management server 22 manages cooking step modules each of which is a module for achieving an operation of a cooking step. For example, a cooking step module is prepared for each is a cooking unit unique to cooking, such as “shredding a cabbage,” “boiling a potato for ten minutes,” and “grilling a fish.” Each of the cooking step modules module developed by a certain developer.

The cooking step module management server 22 discloses cooking step modules, and provides the cooking step modules to developers who wish to use the cooking step modules. Development of recipe programs is achieved by use of cooking step modules provided by the cooking step module management server 22.

The action module management server 23 manages action modules each of which is a module for achieving an action (cooking operation) included in a cooking step. For example, an action module is prepared for each of actions as divisions of a cooking step, such as “peeling potato skin,” “mashing a potato,” and “chopping a potato.” Each of the action modules is a module developed by a certain developer.

The action module management server 23 discloses action modules, and provides the action modules to developers who wish to use the action modules.

Development of cooking step modules is achieved by use of the action modules provided by the action module management server 23.

The recognition algorithm module management server 24 manages recognition algorithm modules each of which is a module for achieving a target recognition operation. The target of the recognition operation includes at least an ingredient and a cooking device used for cooking. For example, an algorithm for each target, such as an algorithm for recognizing a kitchen knife and an algorithm for recognizing an onion is developed to prepare a recognition algorithm module. Each of recognition algorithm modules is a module developed by a certain developer.

The recognition algorithm module management server 24 discloses recognition algorithm modules, and provides the recognition algorithm modules to developers who wish to use the recognition algorithm modules. Development of action modules is achieved by use of recognition algorithm modules provided by the recognition algorithm module management server 24.

The control module management server 25 manages control modules each of which is a module for achieving a control operation for controlling driving of the cooking arm. For example, a control module is prepared for each of control operations as divisions of an action, such as “holding an ingredient” and “pressing an ingredient.” Each of control modules is a module developed by a certain developer.

The control module management server 25 discloses control modules, and provides the control modules to developers who wish to use the control modules. Development of action modules is achieved by use of control modules provided by the control module management server 25.

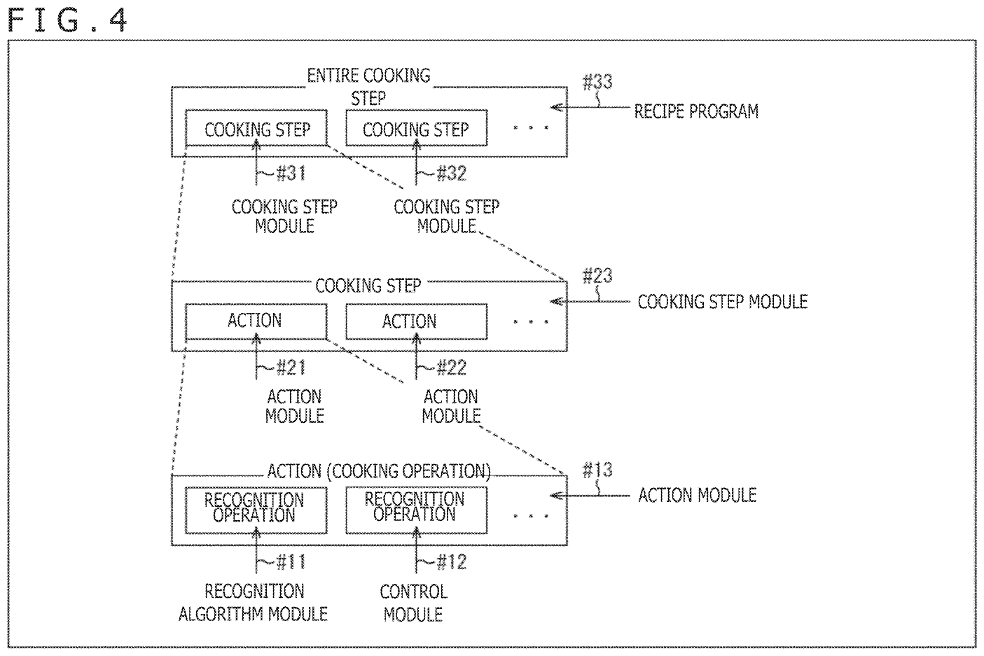

FIG. 4 is a diagram depicting a relation between respective modules.

As depicted in a lower part of FIG. 4, one action which is a cooking operation performed by the cooking robot 3 includes one or multiple recognition operations and one or multiple control operations. The control operation is achieved by use of a target in a state in which the target has been recognized by the recognition operation. One action may include only the recognition operation or only the control operation.

As indicated by an arrow #11, one recognition operation is achieved by execution of one recognition algorithm module. Moreover, as indicated by an arrow #12, one control operation is achieved by execution of one control module. As indicated by an arrow #13, one action is achieved by execution of one action module.

One action module includes one or multiple recognition algorithm modules and one or multiple control modules. Each action module is a higher-order module (program) compared to the recognition algorithm module and the control module.

As depicted in a middle part of FIG. 4, one cooking step includes multiple actions. One cooking step may include only one action.

As indicated by arrows #21 and #22, one action is achieved by execution of one action module. As indicated by an arrow #23, an operation in one cooking step is achieved by execution of one cooking step module.

One cooking step module includes multiple action modules. Each cooking step module is a higher-order module compared to the action modules.

As depicted in an upper part of FIG. 4, an entire cooking step for completing one dish includes multiple cooking steps. The entire cooking step may include only one cooking step.

As indicated by arrows #31 and #32, an operation in one cooking step is achieved by execution of one cooking step module. As indicated by an arrow #33, an operation in the entire cooking step is achieved by execution of one recipe program.

One recipe program includes multiple cooking step modules. Each recipe program is a higher-order program compared to the cooking step modules.

As described above, in the recipe program distribution system depicted in FIG. 1, a series of operations performed by the cooking robot 3 for making one dish are defined in a form divided into units unique to cooking, such as units of the cooking step and units of operations included in each of the cooking steps. Moreover, a module for causing the cooking robot 3 to perform an operation in the corresponding unit for each of the cooking steps or each unit of operations included in each of the cooking steps (action, recognition operation, control operation) is developed and managed.

### <Flow of Development of Recipe Program>

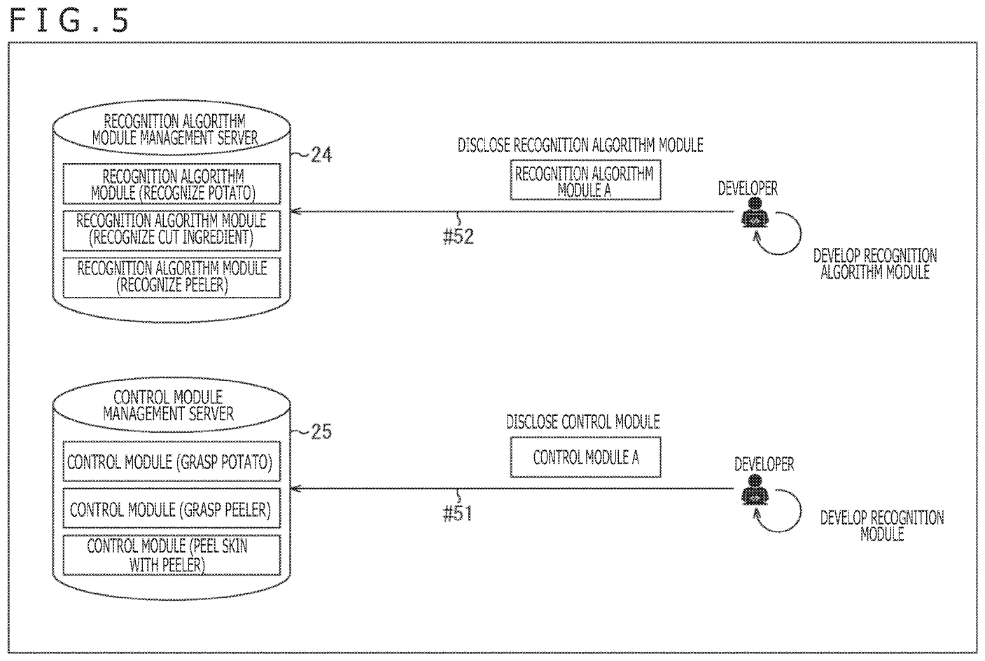

A flow of development of a recipe program will be described with reference to FIGS. 5 to 8.

FIG. 5 is a diagram depicting an example of development of control modules and recognition algorithm modules.

As indicated by an arrow #51, control modules developed by a developer are transmitted from the developer terminal 2 operated by the developer to the control module management server 25, and managed at the control module management server 25.

According to the example in FIG. 5, control modules for respective control operations of “holding a potato,” “holding a peeler,” and “peeing with a peeler” are managed at the control module management server 25 and disclosed to other developers.

As indicated by an arrow #52, recognition algorithm modules developed by a developer are transmitted from the developer terminal 2 operated by the developer to the recognition algorithm module management server 24, and managed at the recognition algorithm module management server 24.

According to the example in FIG. 5, recognition algorithm modules for respective recognition operations of “recognizing a potato,” “recognizing a cut ingredient,” and “recognizing a peeler” are managed at the recognition algorithm module management server 24 and disclosed to other developers.

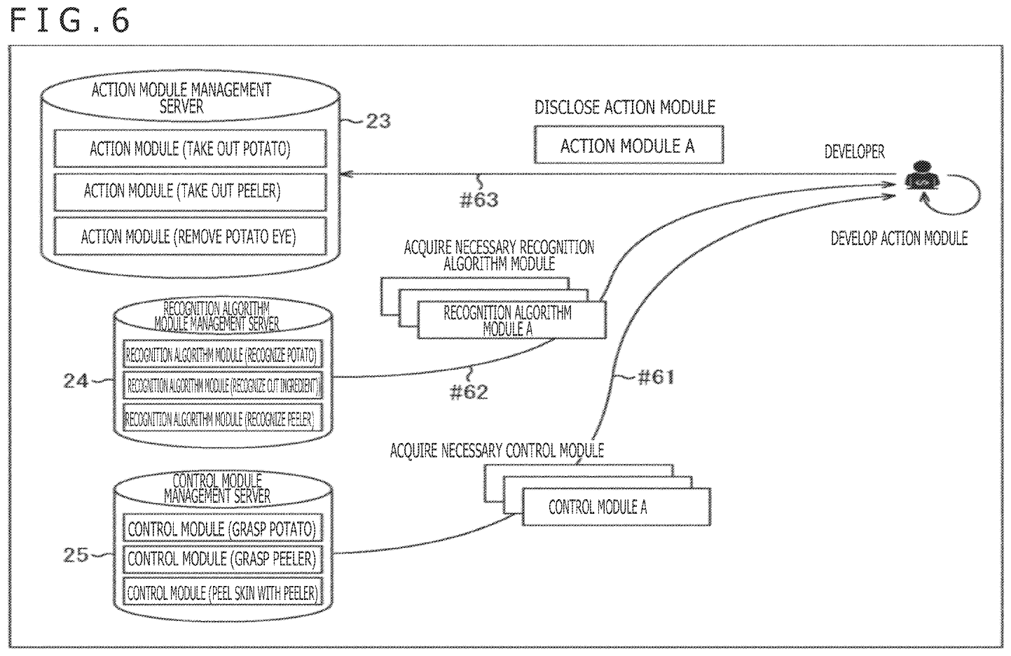

FIG. 6 is a diagram depicting an example of development of action modules.

As indicated by arrows #61 and #62, development of action modules is achieved by use of control modules disclosed at the control module management server 25 and recognition algorithm modules disclosed at the recognition algorithm module management server 24.

As indicated by an arrow #63, action modules developed by a developer are transmitted from the developer terminal 2 operated by the developer to the action module management server 23, and managed at the action module management server 23.

According to the example in FIG. 6, action modules for respective actions of “taking out a potato,” “taking out a peeler,” and “removing potato eyes” are managed at the action module management server 23 and disclosed to other developers.

Various recognition operations and various control operations are required to be performed to achieve one action using the cooking robot 3. In other words, in a case of development of an action module for achieving one action, various recognition algorithm modules for recognition operation and various control modules for control operation are needed. Disclosure of modules that serve as parts constituting the action module enables a developer to easily develop an action module.

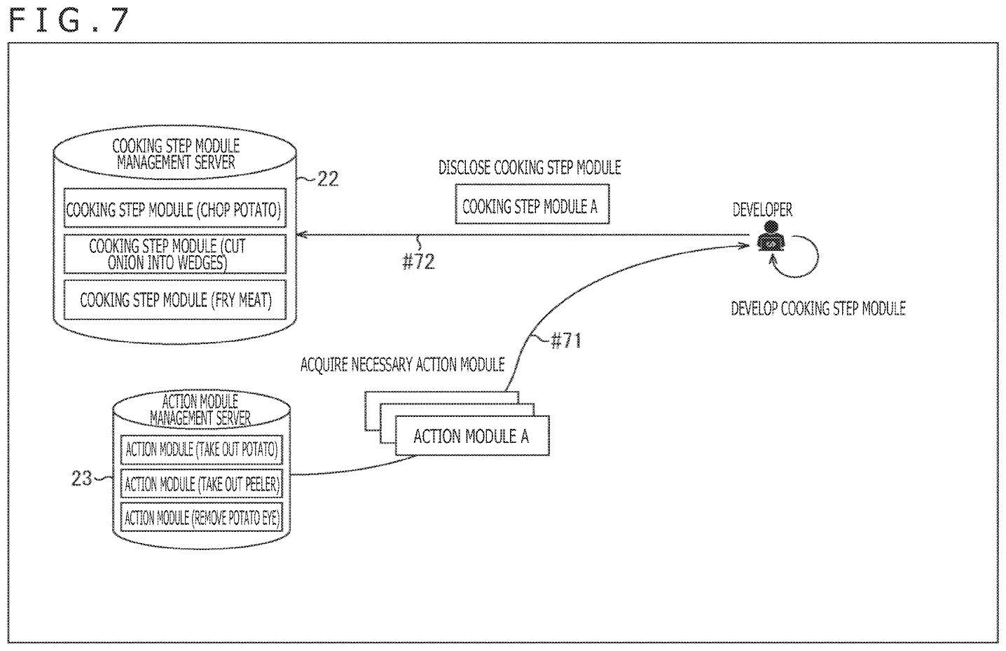

FIG. 7 is a diagram depicting an example of development of cooking step modules.

As indicated by an arrow #71, development of cooking step modules is achieved by use of action modules disclosed at the action module management server 23.

As indicated by an arrow #72, cooking step modules developed by a developer are transmitted from the developer terminal 2 operated by the developer to the cooking step module management server 22, and managed at the cooking step module management server 22.

According to the example in FIG. 7, cooking step modules for respective cooking steps of “chopping a potato,” “cutting an onion into wedges,” and “frying meat” are managed at the cooking step module management server 22 and disclosed to other developers.

Various actions are required to perform one cooking step using the cooking robot 3. In other words, in a case of development of a cooking step module for achieving one cooking step, various action modules for action are needed. Disclosure of modules that serve as parts constituting the cooking step module enables a developer to easily develop a cooking step module.

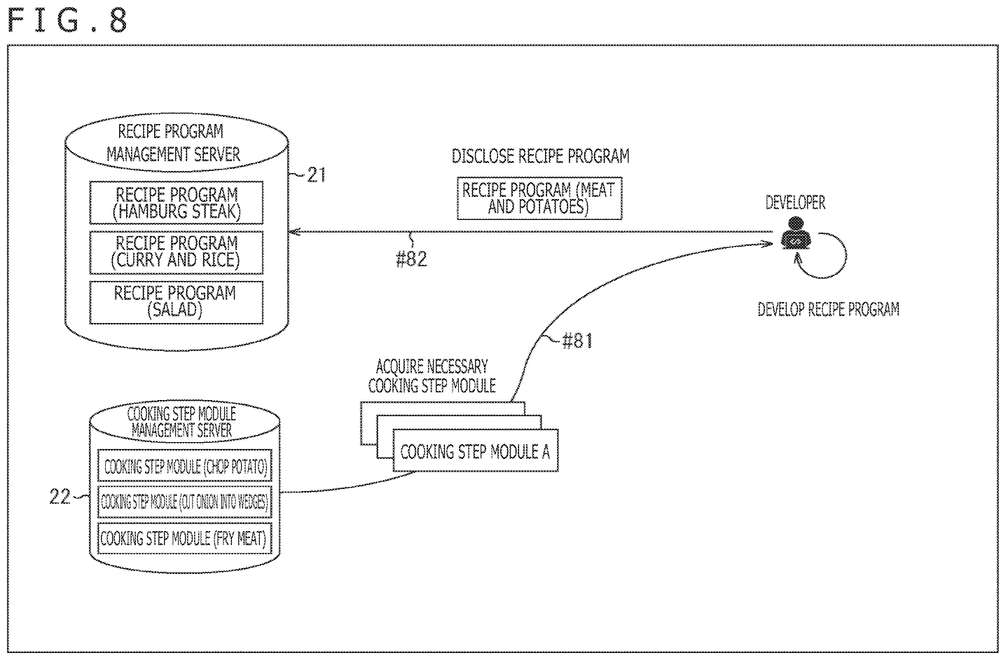

FIG. 8 is a diagram depicting an example of development of recipe programs.

As indicated by an arrow #81, development of recipe programs is achieved by use of cooking step modules disclosed at the cooking step module management server 22.

As indicated by an arrow #82, recipe programs developed by a developer are transmitted from the developer terminal 2 operated by the developer to the recipe program management server 21, and managed at the recipe program management server 21.

In the example depicted in FIG. 8, respective recipe programs for dishes of “hamburg steak,” “curry and rice,” and “salad” are managed at the recipe program management server 21 and disclosed to the cooking robot 3.

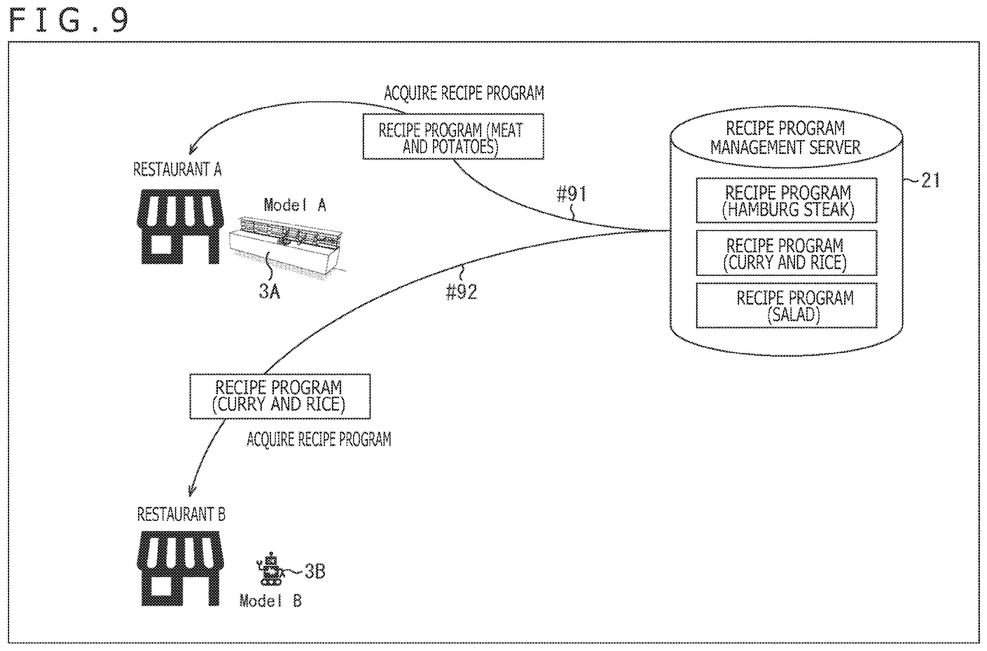

FIG. 9 is a diagram depicting an example of provision of recipe programs.

In the example depicted in FIG. 9, a cooking robot 3A is installed at a restaurant A, while a cooking robot 3B is installed at a restaurant B. The cooking robot 3A and the cooking robot 3B are cooking robots having different specifications such as different hardware configurations.

Multiple recipe programs for respective cooking robots having different specifications are prepared for the recipe program management server 21 as recipe programs for a certain dish. Disclosure of modules constituting parts used for developing high-order programs or modules enables a developer to easily develop programs or modules corresponding to various specifications.

In the example depicted in FIG. 9, a recipe program of “meat and potatoes” corresponding to the specifications of the cooking robot 3A is provided to the cooking robot 3A as indicated by an arrow #91. Further, a recipe program of “curry and rice” corresponding to the specifications of the cooking robot 3B is provided to the cooking robot 3B as indicated by an arrow #92.

For making one dish, the cooking robot 3 needs to perform various cooking steps. In other words, in a case of development of a recipe program for making one dish, cooking step modules for various cooking steps are required. Disclosure of modules that serve as parts constituting a recipe program enables a developer to easily develop a recipe program.

As described above, an environment allowing easy development of recipe programs, cooking step modules, action modules, and the like is provided in the recipe program distribution system. As a result, a threshold of entry into development is lowered for developers, and the developers can efficiently develop recipe programs and the like.

Moreover, modularization is achieved in units having high degrees of reusability, such as a cooking step unit and an action unit. Accordingly, developers can mass-produce recipe programs with use of modules applicable to various recipe programs. Specifically, developers can develop recipe programs corresponding to various dishes and recipe programs corresponding to various specifications of the cooking robot 3.

Activation of the recipe program distribution system in FIG. 1 using the cooking robot 3 is achievable as an ecosystem by various recipe programs being thus prepared.

### Specific Example of Recipe Program

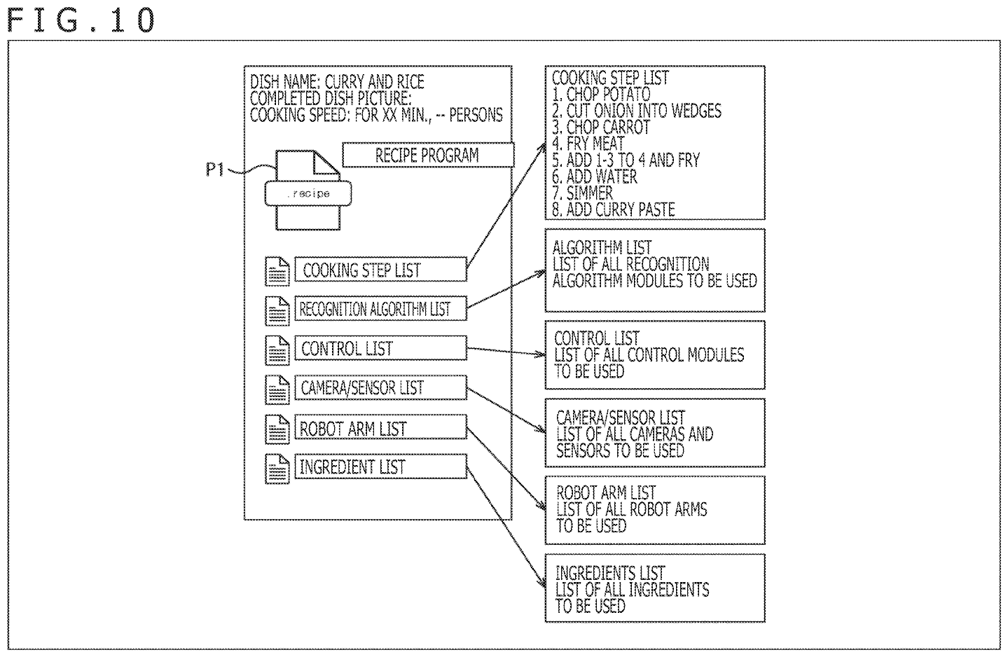

FIG. 10 is a diagram depicting a configuration example of a recipe program.

As depicted in FIG. 10, a cooking step list, a recognition algorithm list, a control list, a camera/sensor list, a robot arm list, and an ingredient list are associated with a recipe program.

A recipe program P1 depicted in FIG. 10 is a recipe program for “curry and rice.” A file extension “.recipe” is set for a file of the recipe program P1. Such attribute information as a picture of completed “curry and rice” and information indicating a cooking speed is added to the recipe program P1.

The recipe program P1 includes cooking step modules for achieving all cooking steps to be taken to complete “curry and rice” and action modules used in the respective cooking step modules. Moreover, the recipe program P1 includes recognition algorithm modules and control modules used in the respective action modules.

The cooking step list is a list of all cooking step modules used to complete “curry and rice.” In the example depicted in FIG. 10, the recipe program P1 includes the following cooking step modules for cooking steps.
1. Chopping a potato
2. Cutting an onion into wedges
3. Chopping a carrot
4. Frying meat
5. Adding the ingredients “1.” to “3.” to the ingredient “4.,” and frying these ingredients
6. Adding water
7. Simmering
8. Adding curry paste

The recognition algorithm list is a list of all recognition algorithm modules used in the recipe program P1.

The control list is a list of all control modules used in the recipe program P1.

The camera/sensor list is a list of all of cameras and sensors used in the recipe program P1. As will be described below, the cooking robot 3 includes cameras and various types of sensors. Ingredients, cooking devices, and the like are recognized by analysis of images captured by the cameras and sensor data detected by the sensors.

The robot arm list is a list of all cooking arms used in the recipe program P1. For example, the cooking robot 3 includes multiple cooking arms.

The ingredient list is a list of all ingredients used in the recipe program P1.

The camera/sensor list and the robot arm list associated with the recipe program P1 are used for determining whether or not “curry and rice” can be made by the cooking robot 3, for example.

In a case where the cooking robot 3 does not meet specifications of the cameras and sensors described in the camera/sensor list, it is determined that the cooking robot 3 is unable to make “curry and rice” under the recipe program P1.

In a case where the cooking robot 3 does not meet specifications of the cooking arms described in the robot arm list, it is similarly determined that the cooking robot 3 is unable to make “curry and rice” under the recipe program P1.

In this case, the necessity of equipping a camera, a sensor, or a cooking arm as an additional part is specified. As described above, the lists concerning the configurations of the cooking robot 3 required for cooking using the respective recipe programs are associated with the corresponding recipe programs.

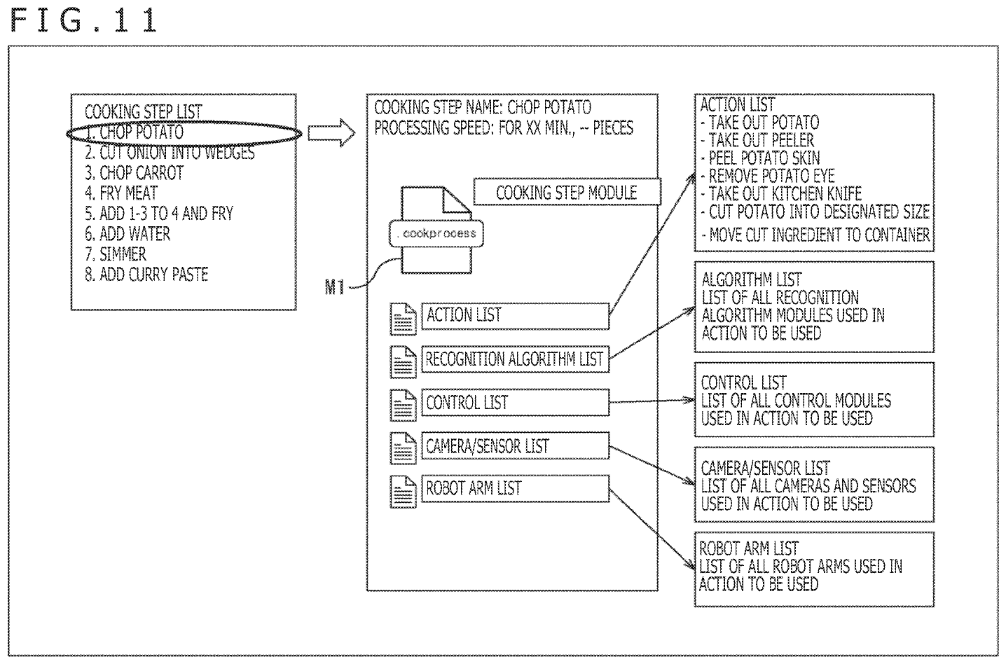

FIG. 11 is a diagram depicting a configuration example of a cooking step module.

A cooking step module M1 depicted in FIG. 11 is a cooking step module for a cooking step of “chopping a potato” included in the cooking steps described with reference to FIG. 10, as surrounded by a flat ellipse. A file extension “cookprocess” is set for a file of the cooking step module M1. Such attribute information as information indicating a processing speed is added to the cooking step module M1.

The cooking step module M1 includes action modules for achieving all actions to be taken to end the cooking step of “chopping a potato.” Moreover, the cooking step module M1 includes recognition algorithm modules and control modules used in the respective action modules.

As depicted in FIG. 11, an action list, a recognition algorithm list, a control list, a camera/sensor list, and a robot arm list are associated with the cooking step module M1.

The action list is a list of all action modules used in the cooking step of “chopping a potato.” In the example depicted in FIG. 11, the cooking step module M1 includes the following action modules for actions.
Taking out a potato
Taking out a peeler
Peeling potato skin
Removing potato eyes
Taking out a kitchen knife
Cutting a potato into pieces of a designated size
Moving cut ingredients to a container

The recognition algorithm list is a list of all recognition algorithm modules used in the cooking step module M1.

The control list is a list of all control modules used in the cooking step module M1.

The camera/sensor list is a list of all of cameras and sensors used in the cooking step module M1.

The robot arm list is a list of all cooking arms used in the cooking step module M1.

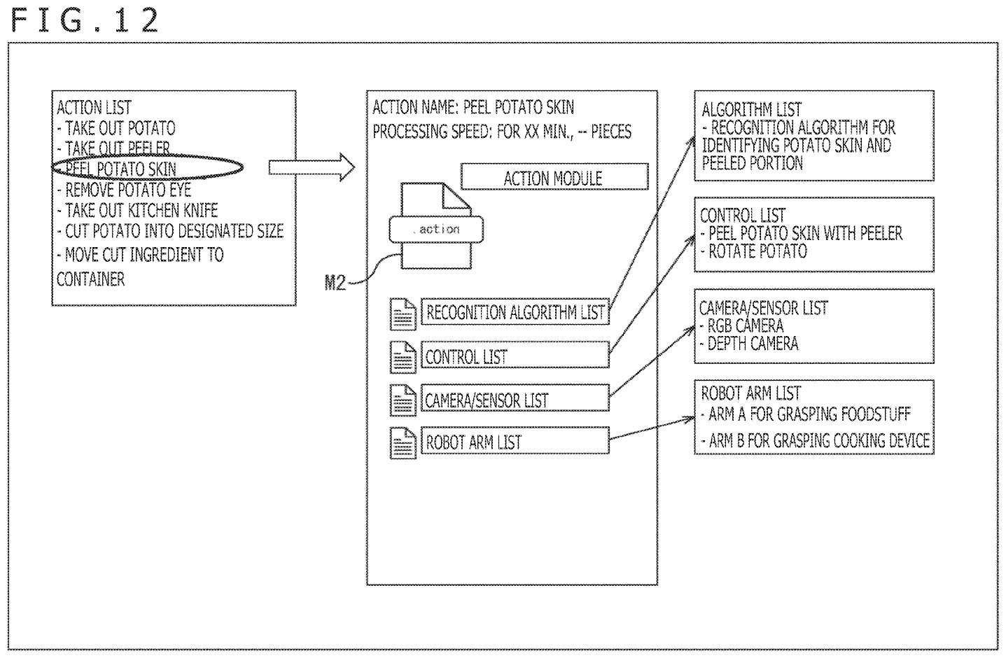

FIG. 12 is a diagram depicting a configuration example of an action module.

An action module M2 depicted in FIG. 12 is an action module for an action of “peeling potato skin” included in the actions described with reference to FIG. 11, as surrounded by a flat ellipse. A file extension “.action” is set for a file of the action module M2. Such attribute information as information indicating a processing speed is added to the action module M2.

The action module M2 includes recognition algorithm modules for achieving all recognition operations and control modules achieving all control operations to be performed to end the action of “peeling potato skin.”

As depicted in FIG. 12, a recognition algorithm list, a control list, a camera/sensor list, and a robot arm list are associated with the action module M2.

The recognition algorithm list is a list of all recognition algorithm modules used in the action module M2. In the example depicted in FIG. 12, a recognition algorithm module of “identifying potato skin and a peeled portion” is included.

The control list is a list of all control modules used in the action module M2. In the example depicted in FIG. 12, respective control modules for control operations of “peeling potato skin with a peeler” and “rotating a potato” are included.

The camera/sensor list is a list of all of cameras and sensors used in the action module M2. In the example depicted in FIG. 12, an RGB camera and a depth camera are used in the action module M2.

The robot arm list is a list of all cooking arms used in the action module M2. In the example depicted in FIG. 12, an “arm A holding an ingredient” and an “arm B holding a cooking device” are used in the action module M2.

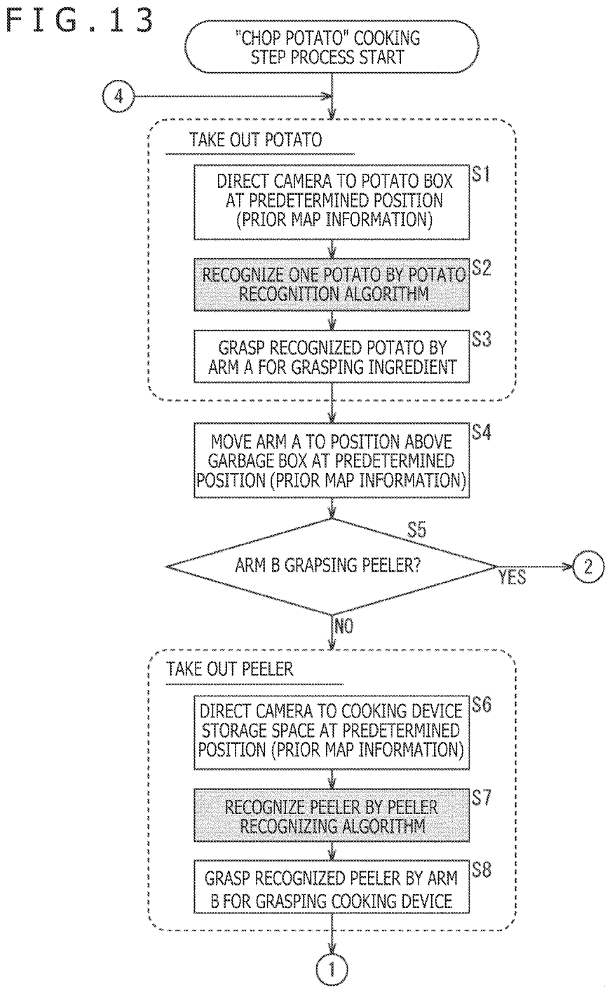

A process performed by the cooking robot 3 in the cooking step of “chopping a potato” will be described here with reference to flowcharts in FIGS. 13 to 17.

Processing from FIGS. 13 to 17 is performed in reference to the cooking step module M1 for the cooking step of “chopping a potato” (FIG. 11) included in the recipe program P1 which is the recipe program for “curry and rice.” The respective actions of “taking out a potato,” “taking out a peeler,” “peeling potato skin,” and up to “moving cut ingredients to a container” are performed by execution of the respective action modules included in the cooking step module M1.

Processing from step S1 to S3 is processing performed in the action of “taking out a potato.” The action of “taking out a potato” is achieved by use of the action module for the action of “taking out a potato.”

In step S1, the cooking robot 3 performs processing for directing the camera to a potato BOX. The potato BOX is provided in the vicinity of the cooking robot 3. Map information which includes information indicating this position is set for the cooking robot 3 beforehand.

In step S2, the cooking robot 3 recognizes one potato stored in the potato BOX by analyzing an image captured by the camera. The potato is recognized by use of a recognition algorithm module for potato recognition included in the action module.

Each processing of colored steps in FIGS. 13 to 17 is processing for a recognition operation performed using the recognition algorithm module. Each processing of non-colored steps is processing for a control operation performed using the control module.

In step S3, the cooking robot 3 holds the recognized potato by the arm A set as a cooking arm for holding an ingredient. The operation for holding the potato is performed using a control module included in the action module as a module for a control operation of holding a potato.

The cooking step of “chopping a potato” proceeds to a state where the potato has been taken out by execution of the action module for the action of “taking out a potato.”

In step S4, the cooking robot 3 moves the arm A toward a position above a garbage BOX. The garbage BOX is provided in the vicinity of the cooking robot 3. Map information which includes information indicating this position is set for the cooking robot 3 beforehand.

In step S5, the cooking robot 3 determines whether or not the arm B set as a cooking arm for holding a cooking device is holding a peeler.

In a case of determining that the arm B is not holding a peeler in step S5, the process proceeds to step S6.

Processing from step S6 to S8 is processing performed in the action of “taking out a peeler.” The action of “taking out a peeler” is achieved by use of the action module for the action of “taking out a peeler.”

In step S6, the cooking robot 3 performs a process for directing the camera to a cooking device storage space. The cooking device storage space is provided in the vicinity of the cooking robot 3. Map information which includes information indicating this position is set for the cooking robot 3 beforehand.

In step S7, the cooking robot 3 recognizes a peeler stored in the cooking device storage space by analyzing an image captured by the camera. The peeler is recognized by use of a recognition algorithm for peeler recognition included in the action module.

In step S8, the cooking robot 3 holds the recognized peeler by the arm B. The operation for holding the peeler is performed using a control module included in the action module as a module for a control operation of holding a peeler.

The cooking step of “chopping a potato” proceeds to a state where the peeler has been taken out by execution of the action module for the action of “taking out a peeler.”

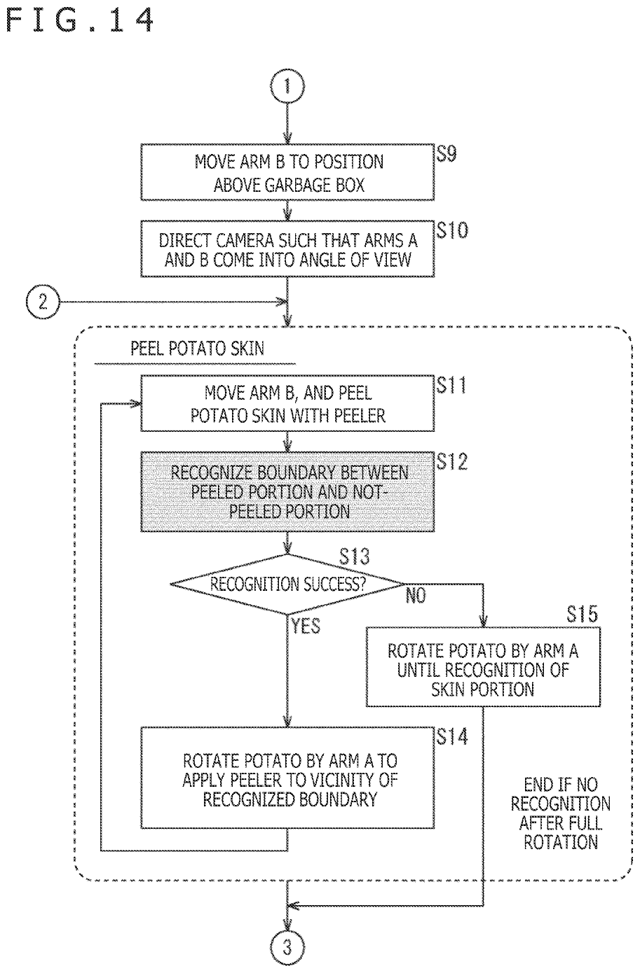

In step S9 (FIG. 14), the cooking robot 3 moves the arm B toward a position above the garbage box.

In step S10, the cooking robot 3 performs processing for directing the camera to such a position that the arm A and the arm B come into an angle of view.

Processing from step S11 to S15 is processing performed in the action of “peeling potato skin.” In a case of determining in step S5 that the arm B is holding a peeler, the process similarly proceeds to step S11 to perform the process for the action of “peeling potato skin.” The action of “peeling potato skin” is achieved by use of the action module for the action of “peeling potato skin.”

In step S11, the cooking robot 3 moves the arm B to peel the skin of the potato by the peeler recognized by the recognition algorithm module for peeler recognition. The operation for peeling potato skin is performed using a control module included in the action module as a module for a control operation of peeling potato skin with a peeler.

In step S12, the cooking robot 3 recognizes a boundary between a portion of the potato already peeled and a portion not peeled, by analyzing an image captured by the camera. The boundary is recognized by use of a recognition algorithm module included in the action module as a module for an operation of recognizing the boundary between the portion of the potato already peeled and the portion not peeled.

In step S13, the cooking robot 3 determines whether or not recognition of the boundary has succeeded.

In a case of determining in step S13 that recognition of the boundary has succeeded, the cooking robot 3 rotates the potato by the arm A in such a manner that the peeler is applied to the vicinity of the recognized boundary in step S14. The operation for rotating the potato with the peeler applied to the vicinity of the boundary is performed using a control module included in the action module as a module for a control operation of rotating a potato.

After the processing in step S14, the process returns to step S11 to repeat the processing described above.

On the other hand, in a case of determining in step S13 that recognition of the boundary has failed, the process proceeds to step S15. In this case, there is no boundary between the portion of the potato already peeled and the portion not peeled, i.e., peeling the potato skin has been completed.

In step S15, the cooking robot 3 rotates the potato by the arm A until recognizing a potato skin portion. The operation for rotating the potato is performed using a control module included in the action module as a module for a control operation of rotating a potato. In a case where no potato skin portion is recognized after full rotation of the potato, the processing in step S15 ends.

The cooking step of “chopping a potato” proceeds to a state where the potato skin has been peeled by execution of the action module for the action of “peeling potato skin.”

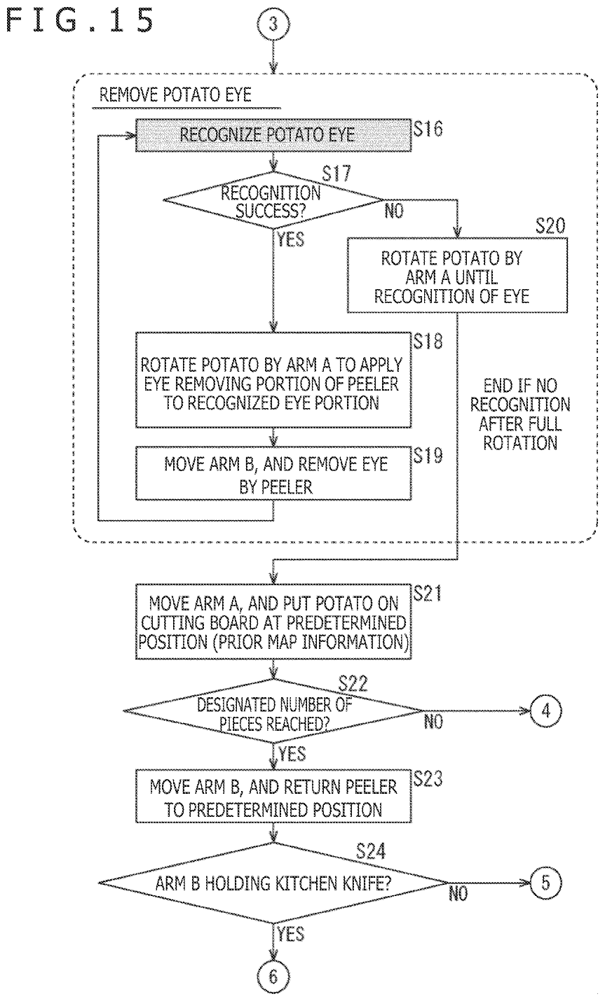

Processing from step S16 to S20 in FIG. 15 is processing performed in the action of “removing potato eyes.” The action of “removing potato eyes” is achieved by use of the action module for the action of “removing potato eyes.”

In step S16, the cooking robot 3 recognizes potato eyes by analyzing an image captured by the camera. The potato eyes are recognized by use of a recognition algorithm module included in the action module as a module for a potato eye recognition operation.

In step S17, the cooking robot 3 determines whether or not recognition of the potato eyes has succeeded.

In a case of determining in step S17 that recognition of the potato eyes has succeeded, the cooking robot 3 rotates the potato by the arm A in such a manner that an eye removing portion of the peeler is applied to the recognized eye portion in step S18. The operation for rotating the potato is performed using a control module included in the action module as a module for a control operation of rotating a potato.

In step S19, the cooking robot 3 moves the arm B to remove the potato eyes by the peeler. The operation for removing the potato eyes by the peeler is performed using a control module included in the action module as a module for a control operation of removing potato eyes.

After the processing in step S19, the process returns to step S16 to repeat the processing described above.

On the other hand, in a case of determining in step S17 that recognition of potato eyes has failed, the process proceeds to step S20.

In step S20, the cooking robot 3 rotates the potato by the arm A until recognizing any potato eye. The operation for rotating the potato is performed using a control module included in the action module as a module for a control operation of rotating a potato. In a case where no potato eye is recognized after full rotation of the potato, the processing in step S20 ends.

The cooking step of “chopping a potato” proceeds to a state where potato eyes have been removed by execution of the action module for the action of “removing potato eyes.”

In step S21, the cooking robot 3 moves the arm A to put the potato on a cutting board located at a predetermined position. The cutting board is provided in the vicinity of the cooking robot 3. Map information which includes information indicating this position is set for the cooking robot 3 beforehand.

In step S22, the cooking robot 3 determines whether or not the number of potatoes put on the cutting board has reached a designated number of pieces. In a case of determining in step S22 that the designated number of pieces has not been reached yet, the process returns to step S1 to repeat the processing described above.

On the other hand, in a case of determining in step S22 that the number of potatoes put on the cutting board has reached the designated number, the process proceeds to step S23, where the cooking robot 3 moves the arm B to return the peeler to the predetermined position.

In step S24, the cooking robot 3 determines whether or not the arm B is holding a kitchen knife.

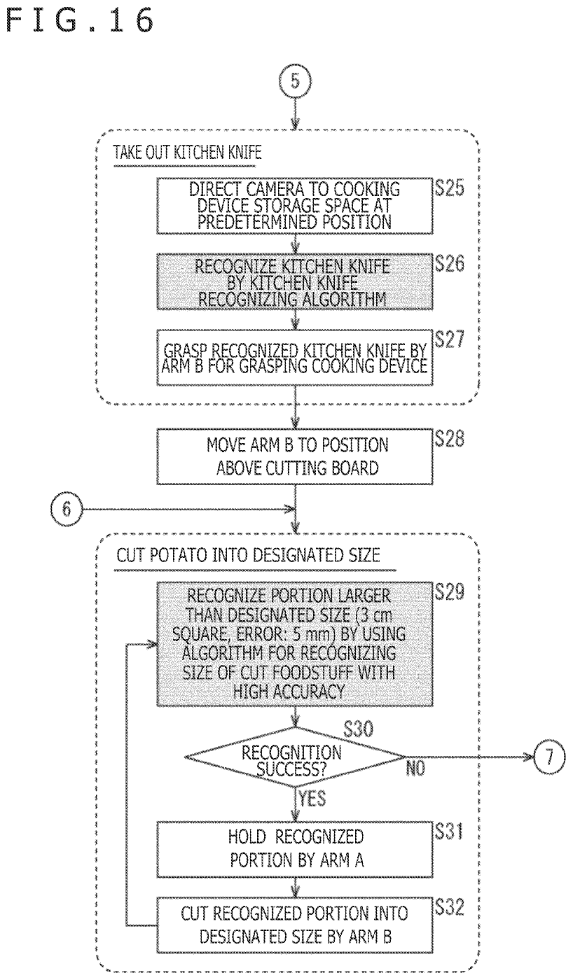

In a case of determining in step S24 that the arm B is not holding a kitchen knife, the process proceeds to step S25 (FIG. 16).

Processing from step S25 to S27 is processing performed in the action of “taking out a kitchen knife.” The action of “taking out a kitchen knife” is achieved using the action module for the action of “taking out a kitchen knife.”

In step S25, the cooking robot 3 performs a process for directing the camera to the cooking device storage space located at the predetermined position.

In step S26, the cooking robot 3 recognizes a kitchen knife stored in the cooking device storage space by analyzing an image captured by the camera. The kitchen knife is recognized by use of a recognition algorithm module for kitchen knife recognition included in the action module.

In step S27, the cooking robot 3 holds the recognized kitchen knife by the arm B. The operation for holding the kitchen knife is performed using a control module included in the action module as a module for a control operation of holding the kitchen knife.

The cooking step of “chopping a potato” proceeds to a state where the kitchen knife has been taken out by execution of the action module for the action of “taking out a kitchen knife.”

In step S28, the cooking robot 3 moves the arm B toward a position above the cutting board.

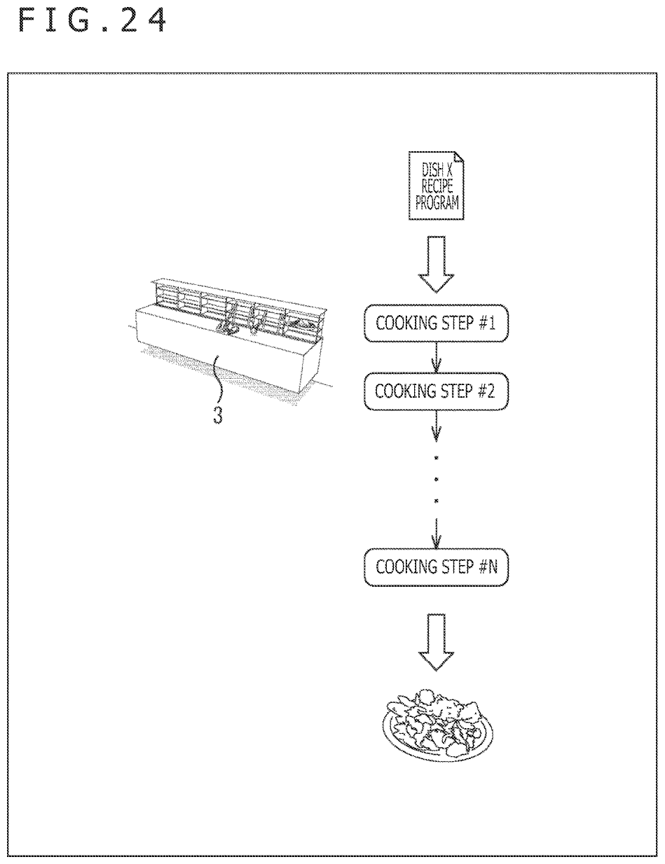

Processing from step S29 to S32 is processing performed in the action of “cutting a potato into pieces of a designated size.” In a case of determining in step S24 that the arm B is holding a cutting knife (FIG. 24), the process similarly proceeds to step S29 to perform the process for the action of “cutting a potato into pieces of a designated size.” The action of “cutting a potato into pieces of a designated size” is achieved using the action module for the action of “cutting a potato into pieces of a designated size.”

In step S29, the cooking robot 3 recognizes a portion larger than the designated size by analyzing an image captured by the camera, with use of an algorithm for recognizing a size of a cut ingredient with high accuracy. For example, a size of 3 cm square is designated with an error up to 5 mm. The size of the cut potato is recognized by use of a recognition algorithm module included in the action module as a module for a cut potato size recognition operation.

In step S30, the cooking robot 3 determines whether or not recognition of a portion larger than the designated size has succeeded.

In a case of determining in step S30 that recognition of a portion larger than the designated size has succeeded, the cooking robot 3 holds the portion recognized to be larger than the designated size by the arm A in step S31. The operation for holding the portion is performed using a control module included in the action module as a module for a control operation of holding an ingredient.

In step S32, the cooking robot 3 cuts the portion recognized to be larger than the designated size into pieces of the designated size with use of the kitchen knife held by the arm B. The operation for cutting with the kitchen knife is performed using a control module included in the action module as a module for a control operation of cutting with a kitchen knife.

After the processing in step S32, the process returns to step S29 to repeat the processing described above.

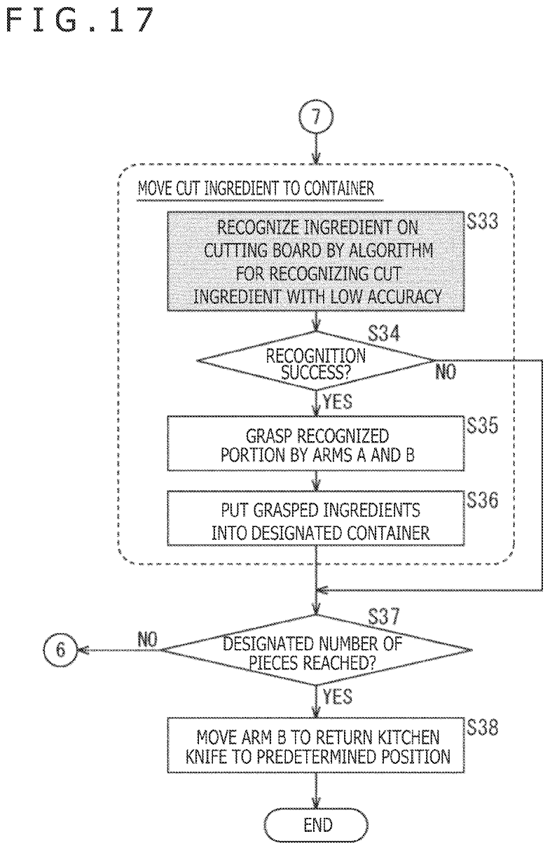

On the other hand, in a case of determining in step S30 that recognition of a portion larger than the designated size has failed, i.e., that a portion larger than the designated size is absent, the process proceeds to step S33 (FIG. 17).

Processing from step S33 to S36 is processing of the action of “moving cut ingredients to a container.” The action of “moving cut ingredients to a container” is achieved using the action module for the action of “moving cut ingredients to a container.”

In step S33, the cooking robot 3 recognizes ingredients on the cutting board by analyzing an image captured by the camera, with use of an algorithm for recognizing cut ingredients with low accuracy. The ingredients are recognized by use of a recognition algorithm module included in the action module as a module for a recognition operation of ingredients on a cutting board.

In step S34, the cooking robot 3 determines whether or not recognition of ingredients on the cutting board has succeeded.

In a case of determining in step S34 that recognition of ingredients on the cutting board has succeeded, the cooking robot 3 grasps the recognized portion by the arm A and the arm B in step S35. The operation for grasping the ingredients is performed using a control module included in the action module as a module for a control operation of holding ingredients.

In step S36, the cooking robot 3 puts the grasped ingredients into a designated container. The operation for putting the ingredients into the designated container is performed using a control module included in the action module as a module for a control operation of putting ingredients into a container.

On the other hand, in a case of determining in step S34 that recognition of the ingredients has failed, the processing in steps S35 and S36 is skipped.

The cooking step of “chopping a potato” proceeds to a state where the cut ingredients have been moved to the container by execution of the action module for “moving cut ingredients to a container.”

In step S37, the cooking robot 3 determines whether or not the number of potatoes moved to the container has reached a designated number. In a case of determining in step S37 that the designated number has not been reached yet, the process returns to step S29 (FIG. 16) to repeat the processing described above.

On the other hand, in a case of determining in step S37 that the number of potatoes shifted to the container has reached the designated number, the process proceeds to step S38, where the cooking robot 3 moves the arm B to return the kitchen knife to the predetermined position.

By the processing described above, the cooking step of “chopping a potato” that is among all of the cooking steps used in the recipe program P1 comes into a completed state. The respective cooking steps from “2.” to “8.” described with reference to FIG. 10 are sequentially performed in a similar manner. As a result, “curry and rice” is eventually completed.

### Examples of Module Combination

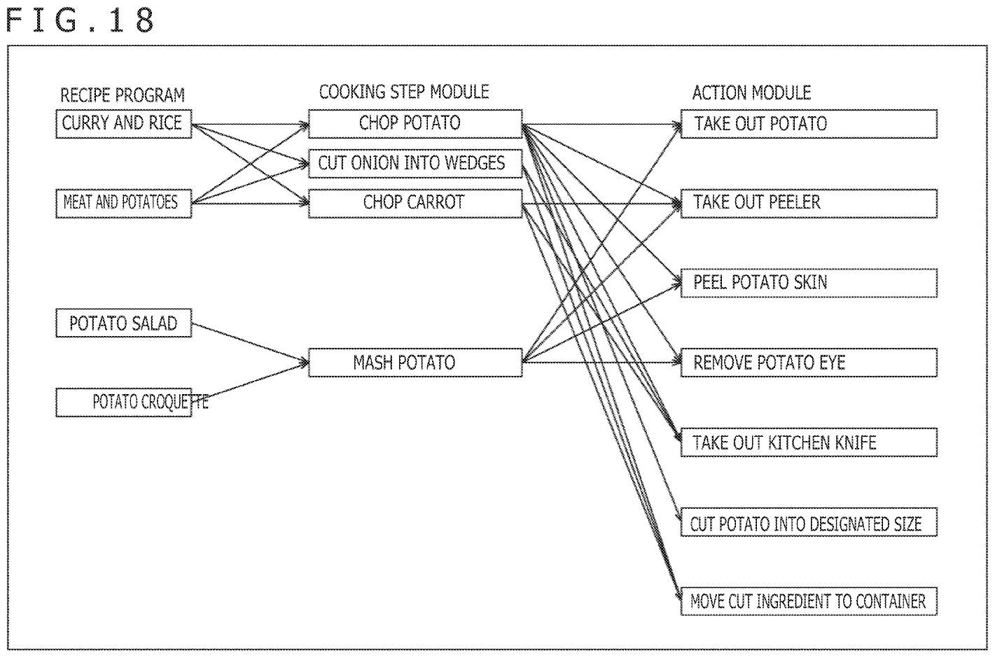

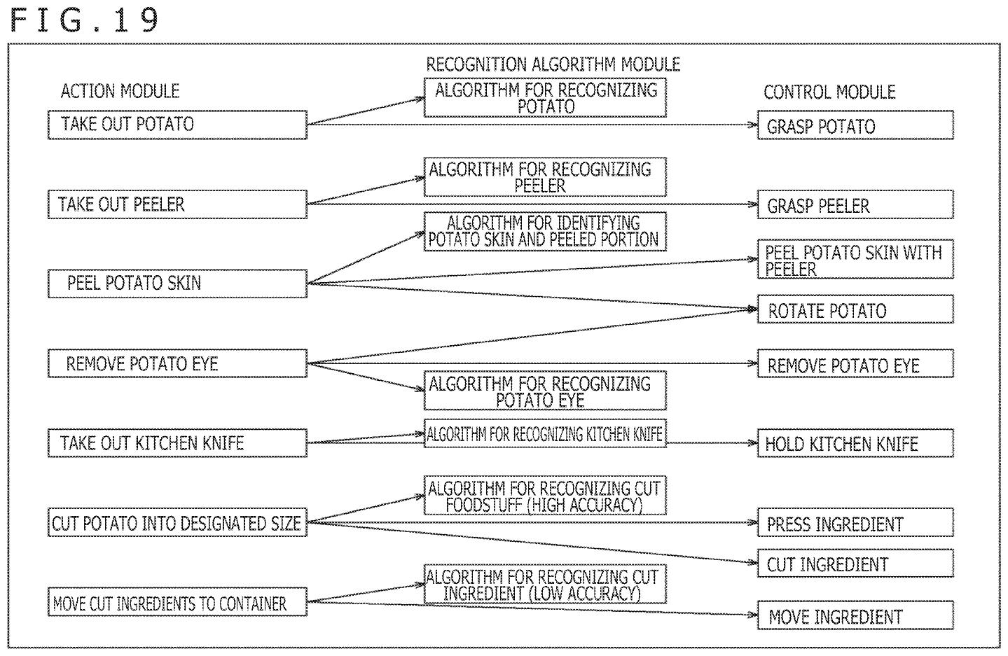

FIGS. 18 and 19 are diagrams each depicting an example of combinations of modules used in a recipe program.

In FIGS. 18 and 19, combinations of modules used in respective recipe programs of four types of dishes including “curry and rice,” “meat and potatoes,” “potato salad,” and “potato croquettes” are indicated with arrows. Note that only partial modules to be used are presented in FIGS. 18 and 19 for convenience of explanation.

As depicted in FIG. 18, each of recipe programs for “curry and rice” and “meat and potatoes” includes cooking step modules for achieving cooking steps of “chopping a potato,” “cutting an onion into wedges,” and “chopping a carrot.”

Each of recipe programs for “potato salad” and “potato croquettes” includes a cooking step module for achieving a cooking step of “mashing a potato.”

The cooking step modules of “chopping a potato,” “cutting an onion into wedges,” and “chopping a carrot” are modules that are used in both the recipe programs for “curry and rice” and “meat and potatoes” and that have high reusability.

Similarly, the cooking step module of “mashing a potato” is a module that is used in both the recipe programs of “potato salad” and “potato croquettes” and that has high reusability.

FIG. 18 depicts combinations of the cooking step module and the action module used in the four types of recipe programs. Further, FIG. 19 depicts combinations of the recognition algorithm module and the control module used in the respective action modules.

A developer of respective modules can contribute to efficient development of recipe programs by preparing modules that are used in various types of recipe programs and thus have high reusability.

### <Configuration of Respective Devices>

Configurations of respective devices constituting the recipe program distribution system will be described here.

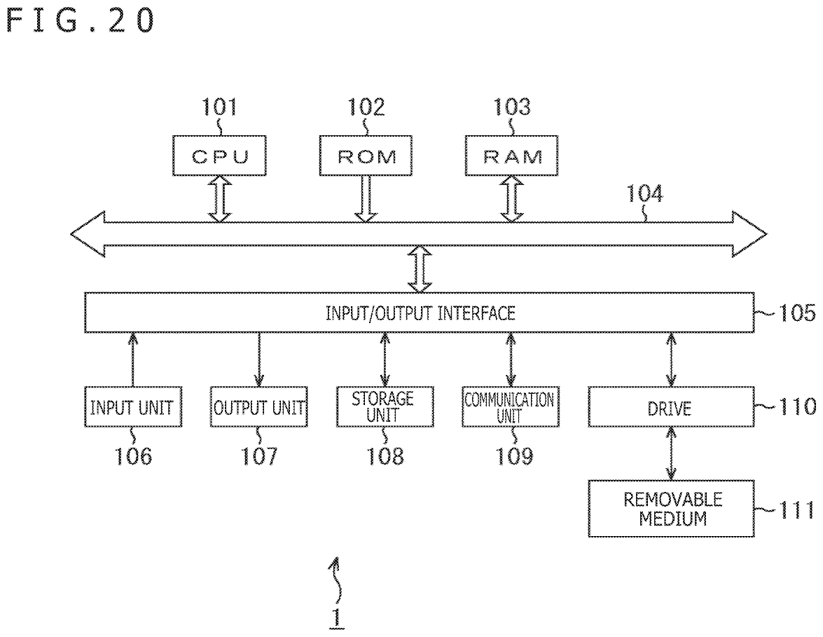

Configuration of application library distribution server 1 FIG. 20 is a block diagram depicting a configuration example of the application library distribution server 1.

As depicted in FIG. 20, the application library distribution server 1 includes a computer. The servers ranging from the recipe program management server 21 to the control module management server 25 may be implemented by one computer, or may be implemented by different computers provided for each. A combination of any two or more servers of the servers ranging from the recipe program management server 21 to the control module management server 25 may be implemented by an identical computer.

A CPU (Central Processing Unit) 101, a ROM (Read Only Memory) 102, and a RAM (Random Access Memory) 103 are connected to one another via a bus 104.

An input/output interface 105 is further connected to the bus 104. An input unit 106 including a keyboard, a mouse, or the like and an output unit 107 including a display, a speaker, or the like are further connected to the input/output interface 105.

Moreover, a storage unit 108 including a hard disk, a non-volatile memory, or the like, a communication unit 109 including a network interface or the like, and a drive 110 for driving a removable medium 111 are connected to the input/output interface 105.

For example, the CPU 101 loads a program stored in the storage unit 108 to the RAM 103 via the input/output interface 105 and the bus 104, and executes the loaded program to perform various processes such as management of recipe programs.

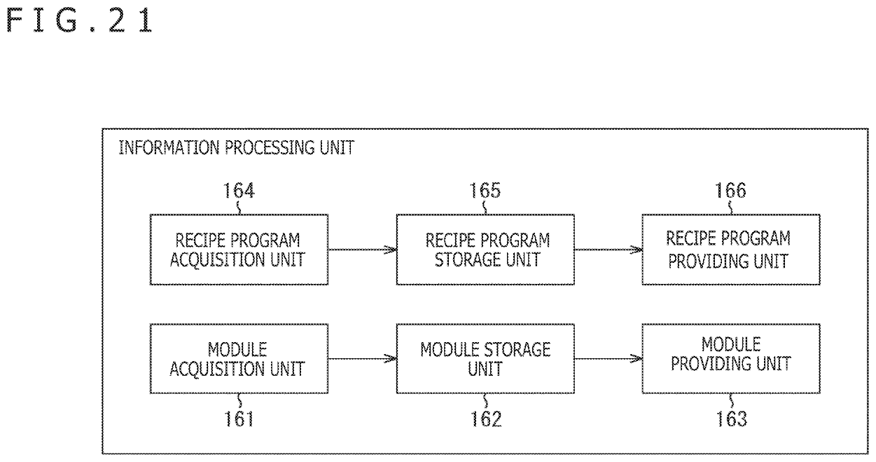

FIG. 21 is a block diagram depicting a functional configuration example of the application library distribution server 1. At least some of function units depicted in FIG. 21 are achieved by execution of a predetermined program by the CPU 101 in FIG. 20.

As depicted in FIG. 21, an information processing unit 151 is implemented in the application library distribution server 1. The information processing unit 151 includes a module acquisition unit 161, a module storage unit 162, a module providing unit 163, a recipe program acquisition unit 164, a recipe program storage unit 165, and a recipe program providing unit 166. The respective function units depicted in FIG. 21 are appropriately implemented by different computers according to the configuration of the computer constituting the application library distribution server 1.

The module acquisition unit 161 receives and acquires modules developed by a certain developer and transmitted from the developer terminal 2. The module acquisition unit 161 acquires control modules, recognition algorithm modules, action modules, and cooking step modules. The module acquisition unit 161 outputs the acquired modules to the module storage unit 162, and stores the modules in the module storage unit 162. The modules stored in the module storage unit 162 are disclosed to developers.

The module providing unit 163 reads modules stored in the module storage unit 162, in response to a request from a developer. The module providing unit 163 transmits the modules read from the module storage unit 162 to the developer terminal 2, to provide the module to the developer terminal 2.

The recipe program acquisition unit 164 receives and acquires recipe programs developed by a certain developer and transmitted from the developer terminal 2. The recipe program acquisition unit 164 outputs the acquired recipe programs to the recipe program storage unit 165, and stores the recipe programs in the recipe program storage unit 165. The recipe programs stored in the recipe program storage unit 165 are disclosed to the manager of the cooking robot 3.

The recipe program providing unit 166 reads recipe programs stored in the recipe program storage unit 165, in response to a request from the manager of the cooking robot 3. The recipe program providing unit 166 transmits the recipe programs read from the recipe program storage unit 165 to the cooking robot 3, to provide the recipe programs to the cooking robot 3.

### Configuration of Developer Terminal 2

As described above, the developer terminal 2 is a computer used by a developer. The developer terminal 2 has a configuration similar to the configuration of the application library distribution server 1 described with reference to FIG. 20. Description will hereinafter be made by using configuration of the application library distribution server 1 in FIG. 21 as the configuration of the developer terminal 2 where appropriate.

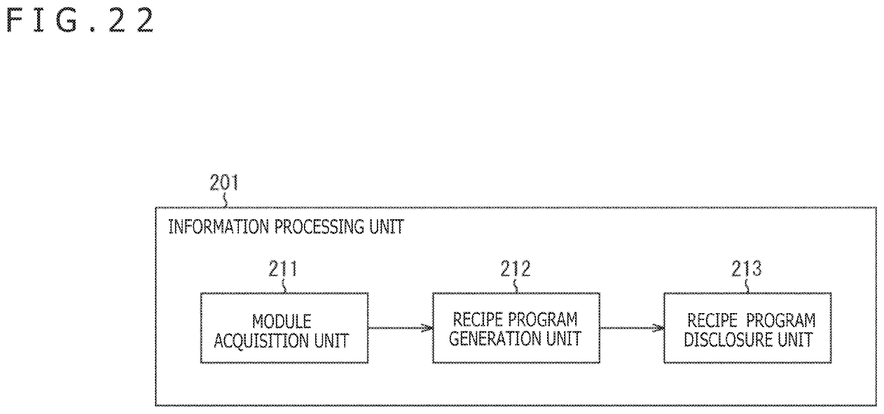

FIG. 22 is a block diagram depicting a functional configuration example of the developer terminal 2. At least some of function units depicted in FIG. 22 are achieved by execution of a predetermined program by the CPU 101 of the developer terminal 2 (FIG. 20).

As depicted in FIG. 22, an information processing unit 201 is provided in the developer terminal 2. The information processing unit 201 includes a module acquisition unit 211, a recipe program generation unit 212, and a recipe program disclosure unit 213. Accordingly, the developer terminal 2 depicted in FIG. 22 is the developer terminal 2 used by a recipe program developer.

The module acquisition unit 211 communicates with the application library distribution server 1, and acquires cooking step modules necessary for generation of a recipe program from the application library distribution server 1 (cooking step module management server 22). Cooking step modules necessary for generation of a recipe program differs for each dish made under the corresponding recipe program or specifications of the targeted cooking robot 3. The cooking step modules acquired by the module acquisition unit 211 are supplied to the recipe program generation unit 212.

The recipe program generation unit 212 generates a recipe program in reference to the cooking step modules acquired by the module acquisition unit 211.

The recipe program here is generated by use of a combination of, according to a dish, action modules, recognition algorithm modules, and control modules each included in the cooking step modules to be made. The recipe program generation unit 212 functions as a generation unit for generating each recipe program by combining any program modules acquired from the application library distribution server 1. The recipe program generated by the recipe program generation unit 212 is supplied to the recipe program disclosure unit 213.

The recipe program disclosure unit 213 transmits the recipe program generated by the recipe program generation unit 212 to the application library distribution server 1, to disclose the recipe program.

Note that the developer terminal 2 used by a developer of each module also has a configuration similar to the configuration depicted in FIG. 22.

### Configuration of Cooking Robot 3

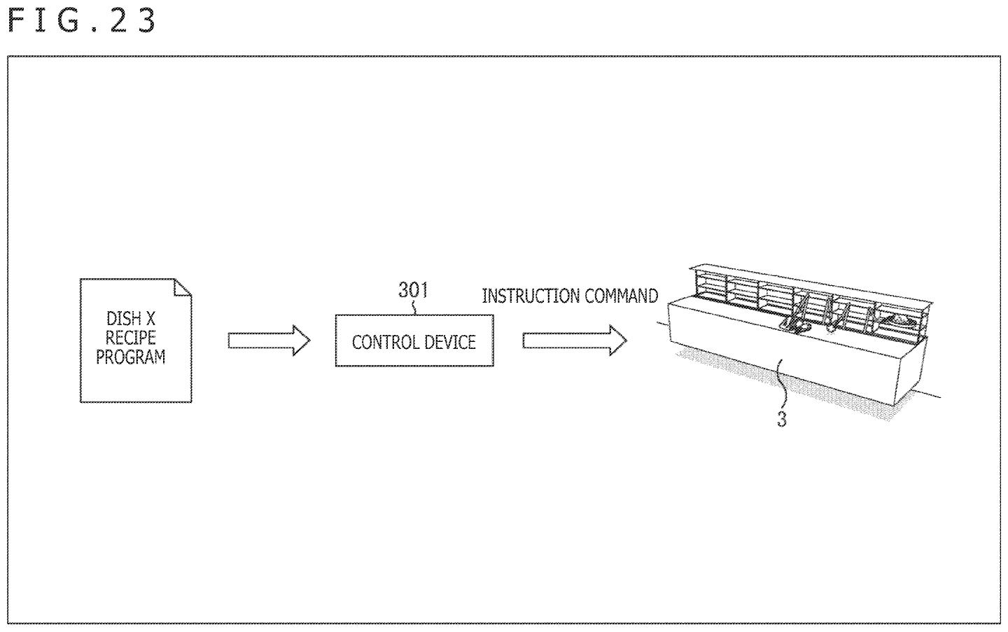

FIG. 23 is a diagram depicting a configuration example of a control system constituting the restaurant side.

As depicted in FIG. 23, the control system provided at a restaurant includes a control device 301 and the cooking robot 3. The control device 301 is a computer which controls cooking performed by the cooking robot 3.

Control of the cooking robot 3 is performed by the control device 301 in reference to a recipe program acquired from the application library distribution server 1. For example, in a case of reception of an order from a guest of the restaurant, the control device 301 outputs instruction commands according to description of the recipe program, to control the cooking robot 3 and cause the cooking robot 3 to make a dish.

Accordingly, at least some of the processes described above are carried out by the control device 301 as processes performed by the cooking robot 3.

The instruction commands include torque of a motor provided on the cooking arm, a driving direction, information for controlling a driving amount, and the like. The instruction commands are sequentially output from the control device 301 to the cooking robot 3 in a period until completion of a dish.

The cooking robot 3 drives respective units such as the cooking arms in accordance with instruction commands supplied from the control device 301, to perform operations of respective cooking steps. As depicted in FIG. 24, a dish is finally completed by performance of operations in respective cooking steps of a cooking step #1, a cooking step #2, and up to a cooking step #N.

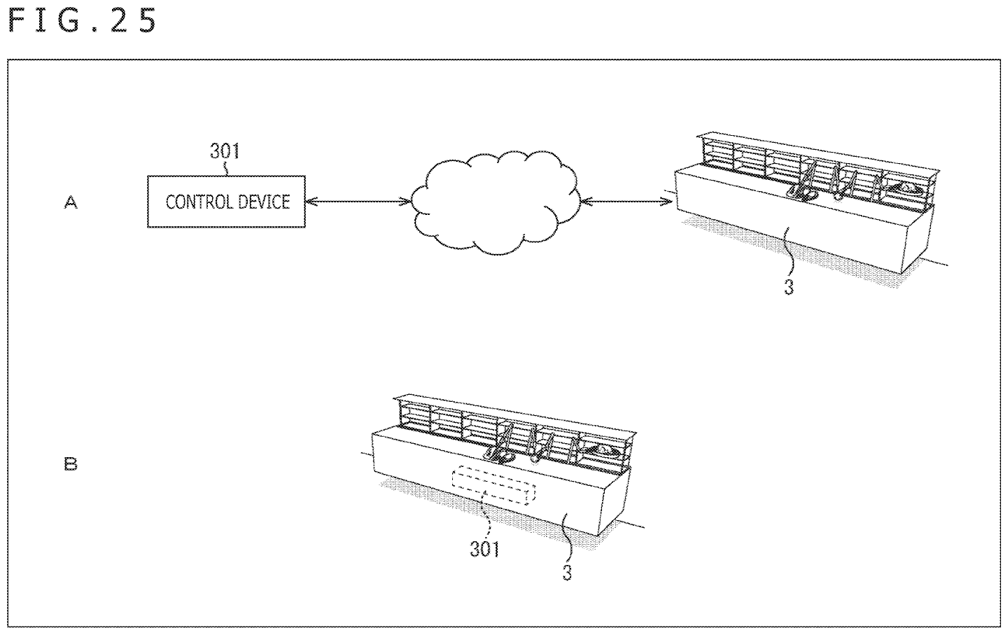

FIG. 25 is a diagram depicting a layout example of the control device 301.

As depicted in A of FIG. 25, the control device 301 is provided as an external device of the cooking robot 3, for example. In the example depicted in A of FIG. 25, the control device 301 and the cooking robot 3 are connected to each other via the network 11 such as the Internet.

Instruction commands transmitted from the control device 301 are received by the cooking robot 3 via the network 11. Images captured by the camera of the cooking robot 3 and various types of data such as sensor data measured by the sensors provided on the cooking robot 3 are transmitted from the cooking robot 3 to the control device 301 via the network 11.

As depicted in B of FIG. 25, the control device 301 may be provided inside a housing of the cooking robot 3. In this case, operations of the respective units of the cooking robot 3 are controlled in accordance with instruction commands generated by the control device 301.

### External Appearance of Cooking Robot

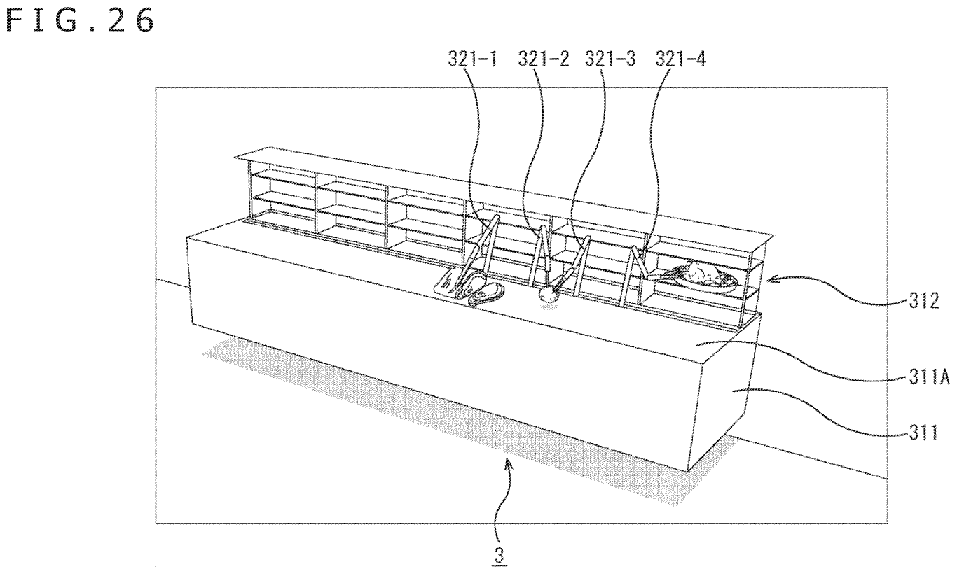

FIG. 26 is a perspective diagram depicting an external appearance of the cooking robot 3.

As depicted in FIG. 26, the cooking robot 3 is a kitchen-type robot which has a housing 311 having a horizontally long rectangular parallelepiped shape. Various types of configurations are formed inside the housing 311 corresponding to a main body of the cooking robot 3.

A cooking assist system 312 is provided on the rear side of the housing 311. Each of spaces defined in the cooking assist system 312 along partitions formed by thin-plate-shaped members has a function of assisting cooking using cooking arms 321-1 to 321-4, such as a refrigerator, a microwave oven, and a storage.

A rail is formed on a top board 311A in a longitudinal direction. The cooking arms 321-1 to 321-4 are provided on the rail. The cooking arms 321-1 to 321-4 are allowed to change their own positions along the rail corresponding to a moving mechanism.

Each of the cooking arms 321-1 to 321-4 is a robot arm formed by cylindrical members being connected at joint portions. Various types of work associated with cooking are performed by the cooking arms 321-1 to 321-4.

A space above the top board 311A corresponds to a cooking space where cooking is achieved by the cooking arms 321-1 to 321-4.

While FIG. 26 depicts four cooking arms, the number of the cooking arms is not limited to four. The cooking arms 321-1 to 321-4 will hereinafter collectively be referred to as cooking arms 321 where appropriate in a case where no distinction between the cooking arms 321-1 to 321-4 is necessary.

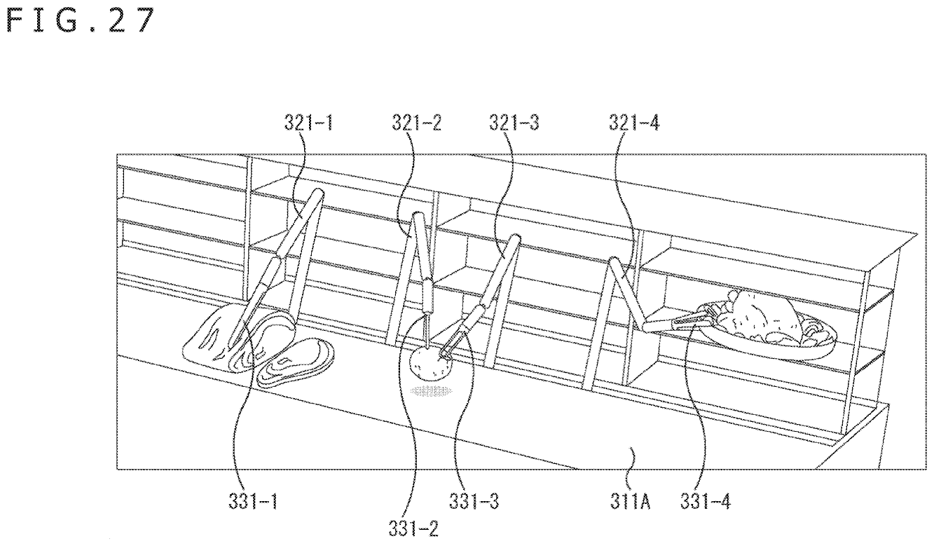

FIG. 27 is a diagram of an enlarged illustration of a state of the cooking arms 321.

As depicted in FIG. 27, attachments having various types of cooking functions are attached to distal ends of the cooking arms 321. Various types of attachments, such as an attachment having a manipulator function (hand function) for grasping an ingredient, a plate, or the like and an attachment having a knife function for cutting an ingredient, are provided as the attachments for the cooking arms 321.

In the example depicted in FIG. 27, a knife attachment 331-1 which is an attachment having the knife function is attached to the cooking arm 321-1. A lump of meat placed on the top board 311A is cut with use of the knife attachment 331-1.

A spindle attachment 331-2 which is an attachment used for fixing or rotating an ingredient is attached to the cooking arm 321-2.

A peeler attachment 331-3 which is an attachment having a function as a peeler for peeling skin of an ingredient is attached to the cooking arm 321-3.

Skin of a potato raised by the cooking arm 321-2 with use of the spindle attachment 331-2 is peeled by the cooking arm 321-3 with use of the peeler attachment 331-3. In such a manner, one work is also achievable by the multiple cooking arms 321 operating in cooperation with each other.

A manipulator attachment 331-4 which is an attachment having a manipulator function is attached to the cooking arm 321-4. A frying pan on which chicken meat is placed is conveyed, with use of the manipulator attachment 331-4, to a space that is included in the cooking assist system 312 and that has an oven function.

Cooking using the cooking arms 321 as described above proceeds while the attachments are replaced according to contents of work as necessary. It is allowed to attach the same attachment to the multiple cooking arms 321, such as a case where the manipulator attachment 331-4 is attached to each of the four cooking arms 321.

Cooking by the cooking robot 3 is achieved using not only attachments provided as tools for cooking arms as described above, but also tools identical to tools used by a human for cooking where appropriate. For example, a knife used by a human is grasped by the manipulator attachment 331-4, and is used for cutting an ingredient or the like for cooking.

### Configuration of Cooking Arm

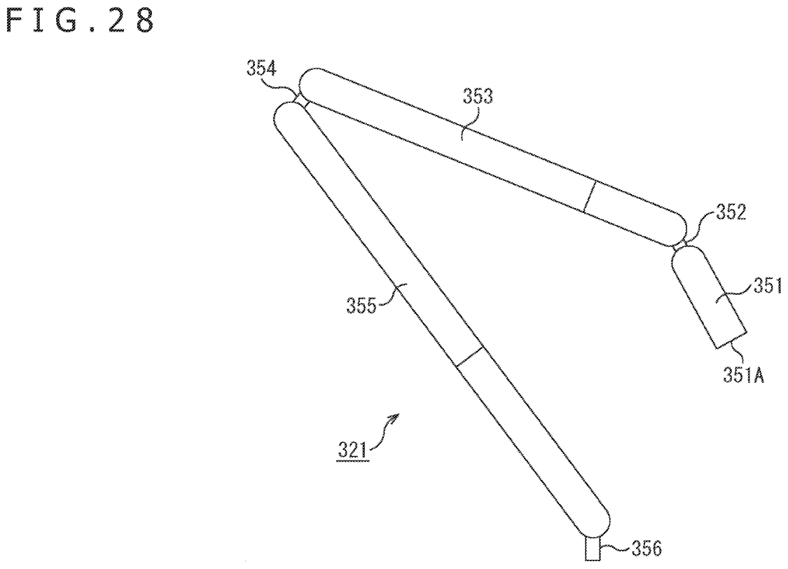

FIG. 28 is a diagram depicting an external appearance of the cooking arm 321.

As depicted in FIG. 28, the cooking arm 321 is generally formed by thin cylindrical members being connected at hinge portions constituting joint portions. A motor or the like which generates force for driving the respective members is provided at each of the hinge portions.

As the cylindrical members, a detachable member 351, a relay member 353, and a base member 355 are provided in this order from a distal end.

The detachable member 351 and the relay member 353 are connected to each other by a hinge portion 352, while the relay member 353 and the base member 355 are connected to each other by a hinge portion 354.

A detachable portion 351A to which the attachment is detachably attached is provided at a distal end of the detachable member 351. The detachable member 351 has the detachable portion 351A to which various types of attachments are detachably attached, and functions as a cooking function arm portion which achieves cooking by operating the attachment.

A detachable portion 356 attached to the rail is provided at a rear end of the base member 355. The base member 355 functions as a moving function arm portion which achieves movement of the cooking arm 321.

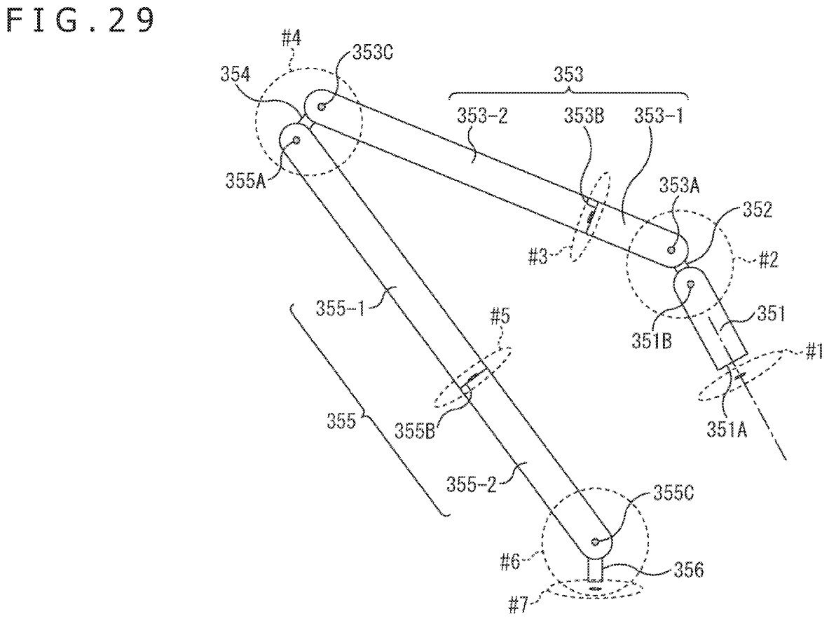

FIG. 29 is a diagram depicting an example of movable ranges of the respective portions of the cooking arm 321.

As surrounded by an ellipse #1, the detachable member 351 is rotatable around a center axis of a circular cross section. A flat small circle presented at the center of the ellipse #1 represents a direction of a rotation axis indicated by a one-dot chain line.

As surrounded by an ellipse #2, the detachable member 351 is rotatable around an axis passing through an engagement portion 351B engaging with the hinge portion 352. In addition, the relay member 353 is rotatable around an axis passing through an engagement portion 353A engaging with the hinge portion 352.

Each of two small circles depicted inside the circle #2 represents a direction of the corresponding rotation axis (a direction perpendicular to the page). Each of a movable range of the detachable member 351 around the axis passing through the engagement portion 351B and a movable range of the relay member 353 around the axis passing through the engagement member 353A is a range having an angle of 90 degrees, for example.

The relay member 353 includes a member 353-1 on the distal end side and a member 353-2 on the rear end side separated from each other. As surrounded by an ellipse #3, the relay member 353 is rotatable around a center axis of a circular cross section at a junction portion 353B between the member 353-1 and the member 353-2. Each of the other movable portions basically has a similar movable range.

As described above, the detachable member 351 having the detachable portion 351A at the distal end, the relay member 353 joining the detachable member 351 and the base member 355, and the base member 355 to the rear end of which the detachable portion 356 is connected are rotatably connected to each other by the hinge portions. Movements of the respective movable portions are controlled by a controller inside the cooking robot 3 in accordance with instruction commands.

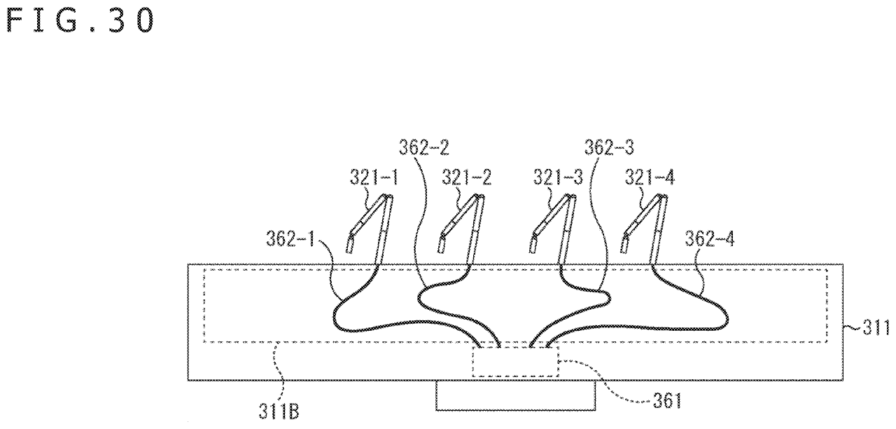

FIG. 30 is a diagram depicting an example of connection between the cooking arms and the controller.

As depicted in FIG. 30, the cooking arms 321 are connected to a controller 361 via wiring within a space 311E formed inside the housing 311. In the example depicted in FIG. 30, the cooking arms 321-1 to 321-4 are connected to the controller 361 via wires 362-1 to 362-4, respectively. The wires 362-1 to 362-4 each having flexibility are bent appropriately according to the positions of the cooking arms 321-1 to 321-4.

### Configuration of Cooking Robot 3

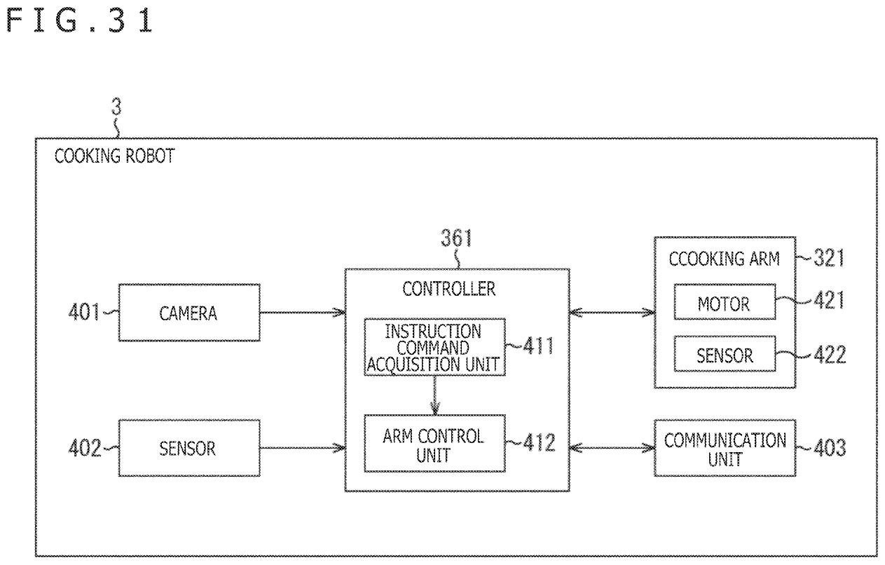

FIG. 31 is a block diagram depicting a configuration example of the cooking robot 3.

The cooking robot 3 is formed by the respective portions being connected to the controller 361 which controls operations of the cooking robot 3.

Configurations Included in the Configurations Depicted in FIG. 31 and identical to the configurations described above are given identical reference numbers. Repetitive description will be omitted where appropriate.

Not only the cooking arms 321, but also a camera 401, a sensor 402, and a communication unit 403 are connected to the controller 361.

The controller 361 includes a computer having a CPU, a ROM, a RAM, a flash memory, and the like. The controller 361 executes a predetermined program by the CPU to control entire operations of the cooking robot 3. The control device 301 may include the controller 361.

For example, by controlling the communication unit 403, the controller 361 transmits images captured by the camera 401 and sensor data measured by the sensor 402 to the control device 301.

The controller 361 executes a predetermined program to implement an instruction command acquisition unit 411 and an arm control unit 412.

The instruction command acquisition unit 411 acquires instruction commands transmitted from the control device 301 and received by the communication unit 403. The instruction commands acquired by the instruction command acquisition unit 411 are supplied to the arm control unit 412.

The arm control unit 412 controls operations of the cooking arms 321 in accordance with the instruction commands acquired by the instruction command acquisition unit 411.

The camera 401 images a state around the cooking robot 3, and outputs an image formed by the imaging to the controller 361. The camera 401 is provided at each of various positions, such as a position in front of the cooking assist system 312 and distal ends of the cooking arms 321.

The sensor 402 includes various types of sensors, such as a temperature/humidity sensor, a pressure sensor, an optical sensor, a distance sensor, a human sensor, a positioning sensor, and a vibration sensor. Measurement by the sensor 402 is made in a predetermined cycle. Sensor data indicating a measurement result obtained by the sensor 402 is supplied to the controller 361.

The camera 401 and the sensor 402 may be provided at positions away from the housing 311 of the cooking robot 3.

The communication unit 403 is a wireless communication module such as a wireless LAN module and a portable communication module corresponding to LTE (Long Term Evolution). The communication unit 403 communicates with external devices such as the control device 301 and the application library distribution server 1.

As depicted in FIG. 31, each of the cooking arms 321 includes a motor 421 and a sensor 422.

The motor 421 is provided at each of the joint portions of the cooking arms 321. The motor 421 performs a rotational operation around an axis under the control of the arm control unit 412. An encoder for measuring a rotation amount of the motor 421, a driver for adaptively controlling rotation of the motor 421 according to a measurement result obtained by the encoder, and the like are also provided at each of the joint portions.

For example, the sensor 422 includes a gyro sensor, an acceleration sensor, a touch sensor, or the like. The sensor 422 measures an angular velocity, an acceleration, or the like of each of the joint portions during operation of the cooking arms 321, and outputs information indicating a measurement result to the controller 361. Sensor data indicating the measurement result obtained by the sensor 422 is also transmitted from the cooking robot 3 to the control device 301 as necessary.

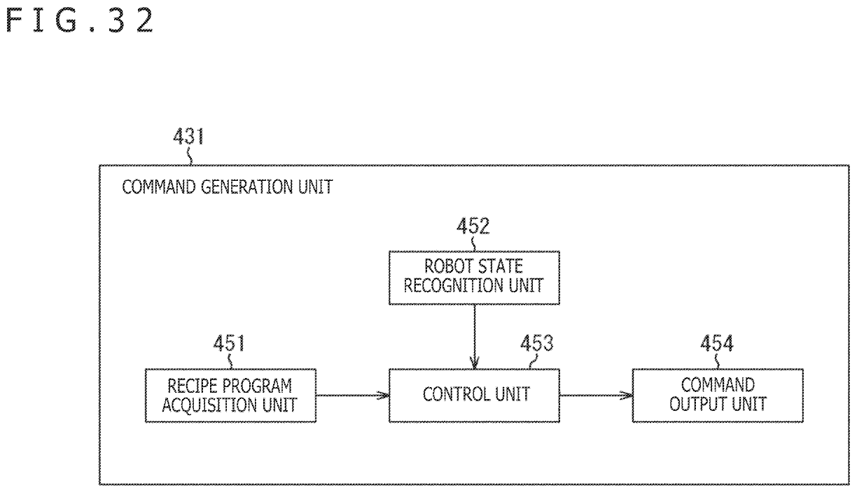

Configuration of Control Device 301 FIG. 32 is a block diagram depicting a functional configuration example of the control device 301.

At least some of function units depicted in FIG. 32 are achieved by execution of a predetermined program by a CPU of a computer constituting the control device 301.

As depicted in FIG. 32, a command generation unit 431 is implemented in the control device 301. The command generation unit 431 includes a recipe program acquisition unit 451, a robot state recognition unit 452, a control unit 453, and a command output unit 454.

The recipe program acquisition unit 451 communicates with the application library distribution server 1 to acquire recipe programs. For example, the recipe program acquisition unit 451 acquires recipe programs for dishes included in a menu offered at a restaurant. The recipe programs acquired by the recipe program acquisition unit 451 are supplied to the control unit 453.

At the time of acquiring recipe programs, the recipe program acquisition unit 451 determines whether or not the cooking robot 3 is capable of performing cooking under the recipe programs, in reference to a list associated with each of the recipe programs. The recipe program acquisition unit 451 acquires recipe programs determined as programs under which cooking is achievable, according to specifications of the cooking robot 3.

For example, in a case where a camera and a sensor identical to a camera and a sensor described in a camera/sensor list associated with a certain recipe program are provided on the cooking robot 3, the recipe program acquisition unit 451 determines that cooking is achievable under this recipe program.

Moreover, in a case where cooking arms meeting specifications described in a robot arm list associated with a certain recipe program are provided on the cooking robot 3, the recipe program acquisition unit 451 determines that cooking is achievable under this recipe program.

In a case where ingredients described in an ingredient list associated with a certain recipe program are provided for the cooking robot 3, the recipe program acquisition unit 451 determines that cooking is achievable under this recipe program.

The robot state recognition unit 452 receives images and sensor data transmitted from the cooking robot 3. An image captured by a camera of the cooking robot 3, and sensor data measured by sensors provided at predetermined positions of the cooking robot 3 are transmitted from the cooking robot 3 in a predetermined cycle. A state around the cooking robot 3 is contained in the image captured by the camera of the cooking robot 3.

The robot state recognition unit 452 recognizes a state around the cooking robot 3 and states of cooking steps, such as a state of the cooking arms 321 and a state of ingredients, by analyzing the image and the sensor data transmitted from the cooking robot 3. The robot state recognition unit 452 performs various types of recognition operations based on a recognition algorithm module. Information indicating a recognition result obtained by the robot state recognition unit 452 is supplied to the control unit 453.

The control unit 453 generates instruction commands for controlling operations of the cooking robot 3, in reference to description contained in a recipe program supplied from the recipe program acquisition unit 451. For example, the control unit 453 generates instruction commands for causing the cooking arms 321 to perform control operations according to control modules.

The instruction commands are generated with reference to a state around the cooking robot 3 as well, for example, as a state recognized by the robot state recognition unit 452. The instruction commands generated by the control unit 453 are supplied to the command output unit 454.

The command output unit 454 transmits the instruction commands generated by the control unit 453 to the cooking robot 3.

### <Operations of Respective Devices>

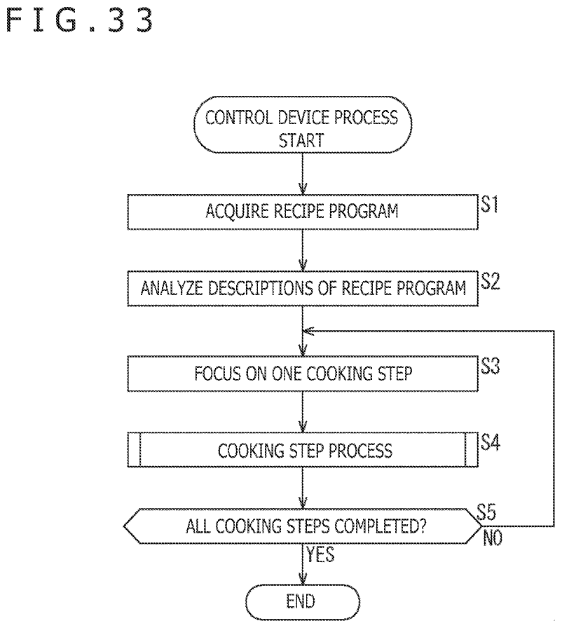

A process performed by the control device 301 which controls operations of the cooking robot 3 will hereinafter be described with reference to a flowchart in FIG. 33.

In step S1, the recipe program acquisition unit 451 communicates with the application library distribution server 1 to acquire a recipe program.

In step S2, the control unit 453 analyzes descriptions of the recipe program.

In step S3, the control unit 453 focuses on one cooking step included in the recipe program. The control unit 453 here sequentially focuses on the cooking step from the head.

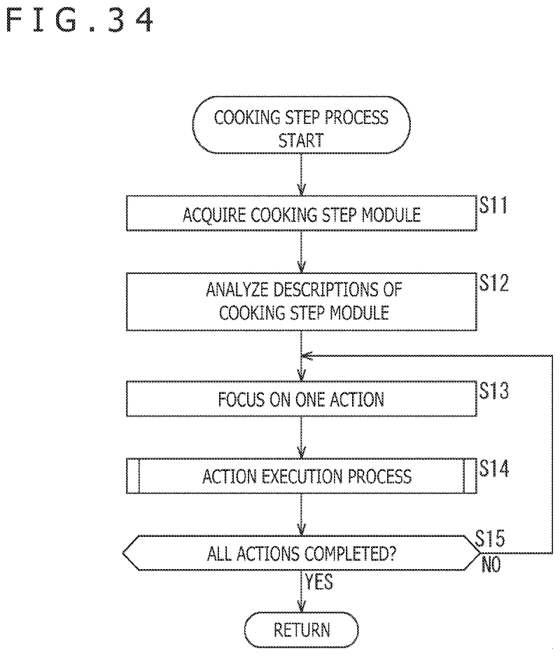

In step S4, the control unit 453 performs a cooking step process. The cooking step process is a process for performing an operation of a cooking step of interest, according to a cooking step module. The cooking step process will be described later with reference to a flowchart in FIG. 34.

In step S5, the control unit 453 determines whether or not all the cooking steps have been completed. In a case of determining that all the cooking steps have not been completed yet, the flow returns to step S3 to repeat the processing described above for the next cooking step of interest.

On the other hand, in a case of determining in step S5 that all the cooking steps have been completed, the process ends.

The cooking step process performed in step S4 in FIG. 33 will be described with reference to the flowchart in FIG. 34.

In step S11, the control unit 453 acquires a cooking step module of the cooking step of interest.

In step S12, the control unit 453 analyzes descriptions of the cooking step module.

In step S13, the control unit 453 focuses on one action that is among multiple actions included in the cooking step module. The control unit 453 here sequentially focuses on the action from the head.

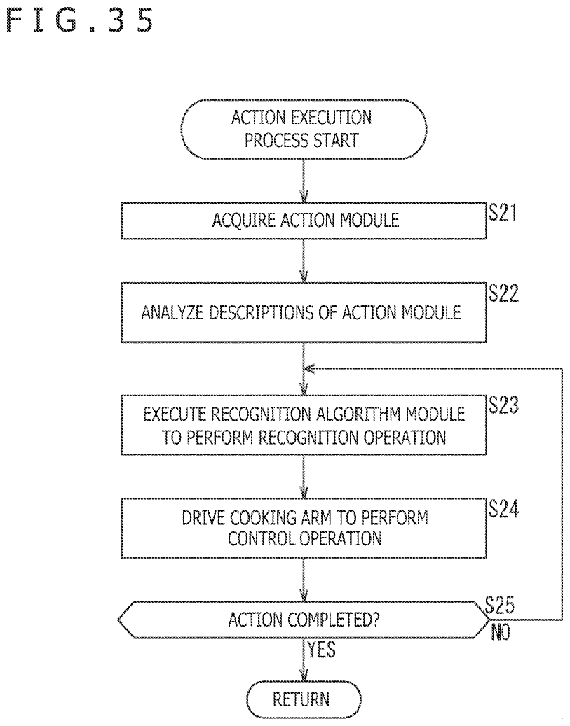

In step S14, the control unit 453 performs an action execution process. The action execution process is a process for performing an operation of an action according to an action module. The action execution process will be described later with reference to a flowchart in FIG. 35.

In step S15, the control unit 453 determines whether or not all the actions have been completed. In a case of determining that all the actions have not been completed yet, the flow returns to step S13 to repeat the processing described above for the next action of interest.

On the other hand, in a case of determining in step S15 that all the actions have been completed, the flow returns to step S4 in FIG. 33 to perform the following processing. The cooking step process described above corresponds to the process described with reference to FIGS. 13 to 17.

The action execution process performed in step S14 in FIG. 34 will be described with reference to a flowchart in FIG. 35.

In step S21, the control unit 453 acquires an action module of an action of interest.

In step S22, the control unit 453 analyzes descriptions of the action module.

In step S23, the control unit 453 controls the robot state recognition unit 452 to perform a recognition operation by execution of a recognition algorithm module included in the action module, for example.

In step S24, the control unit 453 performs a control operation by executing a control module included in the action module. The control unit 453 generates instruction commands for driving the cooking arms, and outputs the generated instruction commands from the command output unit 454.

In step S25, the control unit 453 determines whether or not the actions have been completed. In a case of determining that the actions have not been completed yet, the flow returns to step S23 to repeat the processing described above.

In a case of determining in step S25 that the actions have been completed, the flow returns to step S14 in FIG. 34 to perform the following processing.

By the series of processing described above, operations of the cooking robot 3 are controlled according to cooking step modules, action modules, recognition algorithm modules, and control modules included in the recipe program.

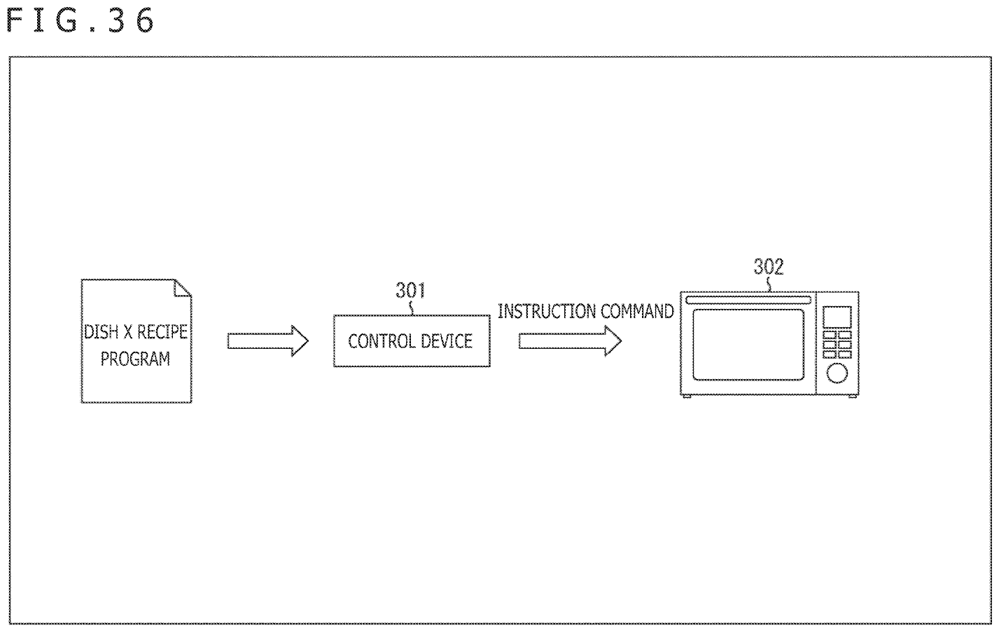

FIG. 36 is a diagram depicting another configuration example of the control system.

A control system depicted in FIG. 36 includes an electronic cooking device 302 such as a microwave oven instead of the cooking robot 3. The electronic cooking device 302 performs a cooking operation in accordance with instruction commands supplied from the control device 301, to perform cooking.

As described above, control for various types of devices each automatically performing a cooking operation is achievable by use of a recipe program provided for the recipe program distribution system. Accordingly, a device corresponding to a control target under a recipe program is not limited to the cooking robot 3 which drives the cooking arms to perform cooking.

Modules developed for various electronic cooking devices according to specifications are disclosed for the recipe program distribution system. A developer can easily develop recipe programs and modules by using modules corresponding to specifications of electronic cooking devices.

<<Second embodiment: mechanism for reward calculation A mechanism for allowing a developer to receive a reward sufficient for an outcome is needed to promote development of recipe programs and modules. A quantitative method is required to measure an outcome.

According to the recipe program distribution system, a reward is paid to a developer according to a use status of a recipe program or of each module used in a recipe program. For example, a reward amount is calculated on the basis of the number of times of use and a use period.

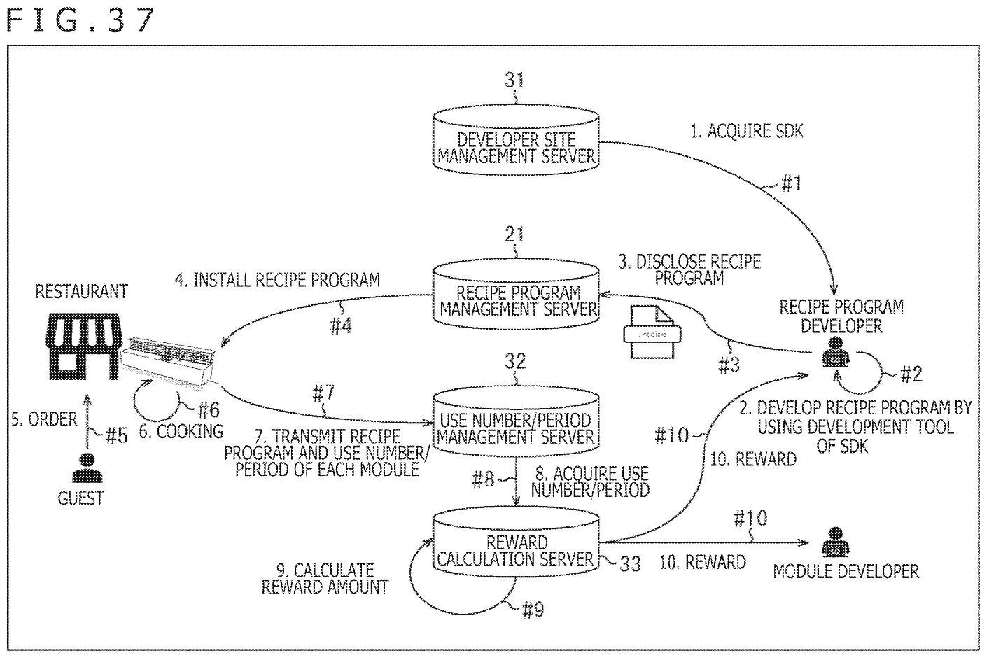

FIG. 37 is a diagram depicting a flow of payment of a reward in the recipe program distribution system.

FIG. 37 depicts a developer site management server 31, a use number/period management server 32, and a reward calculation server 33 constituting the application library distribution server 1, in addition to the recipe program management server 21 described above. The developer site management server 31, the use number/period management server 32, and the reward calculation server 33 may constitute external servers of the application library distribution server 1.

The developer site management server 31 manages sites for developers as web sites for recipe program developers. A recipe program developer operates the developer terminal 2 to access a site for developers and acquires SDK as indicated by an arrow #1.

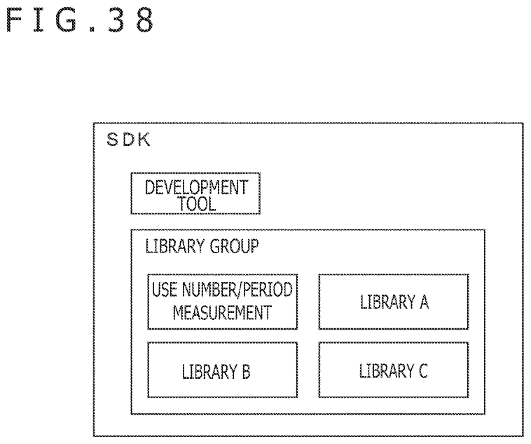

FIG. 38 is a diagram depicting a configuration example of SDK.

As depicted in FIG. 38, SDK includes a library group as well as a development tool. The library group includes a use number/period measuring library which is a library for achieving a function of measuring the number of times of use and a use period. For example, the cooking robot 3 (control device 301) measures the number of times of use and a use period of a program by using the use number/period measuring library.

The number of times of use and the use period of the program measured by use of the use number/period measuring library includes the number of times of use and a use period of a recipe program and numbers of times of use and use periods of respective modules.

The number of times of use of the recipe program is the number of times of execution of the recipe program. The number of times of use of the recipe program is identical to the number of times of making the same dish. The use period of the recipe program is a period of execution of the recipe program.

On the other hand, the number of times of use of each of the modules is the number of times of execution of the corresponding module. The use period of each of the modules is a period of execution of the corresponding module. Basically, the number of times of execution and the use period increase as reusability of the module becomes higher.

As indicated by an arrow #2 in FIG. 37, the recipe program developer develops recipe programs by using cooking step modules acquired from the cooking step module management server 22 as necessary, for example, and generates a package including the recipe programs by using the development tool of SDK.

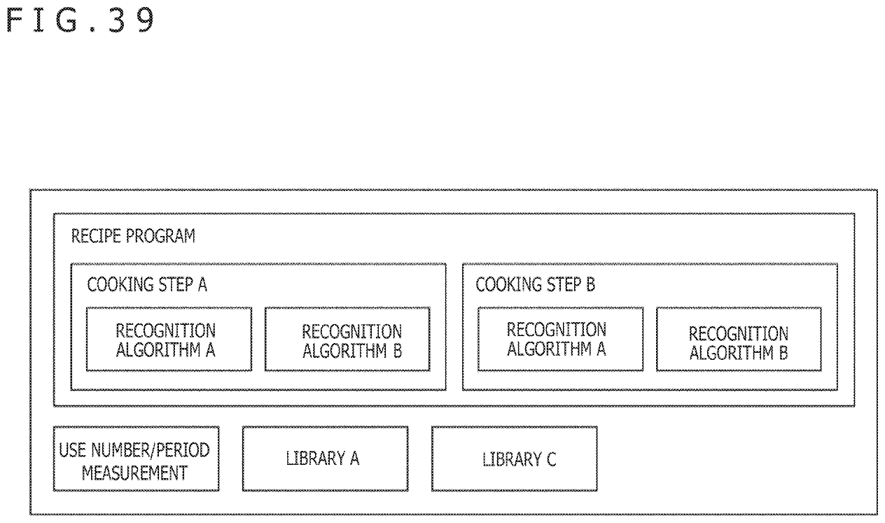

FIG. 39 is a diagram depicting an example of a package including a recipe program.

As depicted in FIG. 39, a package is formed by various types of libraries including the use number/period measuring library being added to the recipe program. In the example depicted in FIG. 39, a library A and a library C provided from the developer site management server 31 with use of SDK are included in the package together with the use number/period measuring library.

As indicated by an arrow #3 in FIG. 37, the recipe program developer transmits a package including the recipe programs developed by the developer to the recipe program management server 21 to disclose the recipe programs.

The manager of the cooking robot 3 selects a recipe program of a preferred dish from the recipe programs disclosed at the recipe program management server 21, and downloads the selected recipe program to install the recipe program in the cooking robot 3 as indicated by an arrow #4.

For example, the cooking robot 3 performs cooking as indicated by an arrow #6 in response to reception of an order from a guest as indicated by an arrow #5. During cooking by the cooking robot 3, the number of times of use and a use period of each program is measured using the use number/period measuring library included in the package. The processes described above are performed according to the recipe program. When the dish is completed, the dish is offered to the guest.

As indicated by an arrow #7, the cooking robot 3 transmits information indicating the number of times of use and the use period measured using the use number/period measuring library to the use number/period management server 32. The information indicating the number of times of use and the use period of the program may periodically be transmitted, or may be transmitted every time cooking is performed. The use number/period management server 32 manages information transmitted from each of the cooking robots 3 installed at various places.

As indicated by an arrow #8, the reward calculation server 33 acquires information indicating the number of times of use and the use period of the program, and calculates a reward amount as indicated by an arrow #9 in reference to the acquired information. The reward amount is calculated in consideration of a value of the program determined on the basis of the number of times of use and the use period of the program.

The reward calculation server 33 has information referred to when calculating respective values of the recipe program, the cooking step modules, the action modules, the recognition algorithm modules, and the control modules. For example, each value of the recognition algorithm modules is represented by the following equation (1).

[Math. 1]

Value of recognition algorithm module=Σᵢαᵢ·xᵢ (1)

In Equation (1), parameters αᵢ and xᵢ as parameters for determining the value of the recognition algorithm module have the following meanings. For calculation of the value of the recognition algorithm module, parameters x₁, x₂, x₃, and x₄ are used, for example.

x₁: number of times of use of module

x₂: use period of module

x₃: proportion of weight of waste portion to weight of ingredient before cooking

x₄:misrecognition ratio

αᵢ:coefficient of each parameter (−1≤αᵢ≤1)

For example, the value of the coefficient αᵢ is set to such a value which increases the value of the recognition algorithm module as the number of times of use or the use period increases.

Similarly, the value of the coefficient αᵢ is set to such a value which increases the value of the recognition algorithm module as the proportion of the weight of the waste portion to the weight of the ingredient before cooking or the misrecognition ratio lowers. Note that the misrecognition ratio may be obtained according to the number of ingredients not recognized and not used by the cooking robot 3.

The package of the recipe program also includes a library for measuring, during cooking, the proportion of the weight of the waste portion to the weight of the ingredient before cooking, a library for measuring the misrecognition ratio, and the like as necessary.

For example, the reward calculation server 33 calculates a reward amount for the developer of the recognition algorithm module by multiplying the value of the recognition algorithm module calculated in such a manner by the number of dishes made and offered with use of the recognition algorithm module. The reward amount of the recognition algorithm module is represented by the following equation (2).

[Math. 2]

Reward amount=number of offered dishes×value of recognition algorithm module (2)

The reward calculation server 33 calculates reward amounts of the recipe program, the cooking step modules, the action modules, the recognition algorithm modules, and the control modules for the respective developers in the manner described above. The reward calculation server 33 pays rewards corresponding to the calculated amounts to the developer of the recipe program and the developers of the respective modules as indicated by an arrow #10 in FIG. 37.

In such a manner, the recipe program distribution system pays a reward to a developer according to the number of times of use, a use period, or the like. This system can increase motivation for developing a recipe program and modules each used a large number of times, i.e., having a high value.

According to the above description, the cooking robot 3 side measures a use status of a program including the number of times of use and a use period. However, the use number/period management server 32 may measure and manage the number of times of use and a use period.

The method for calculating a value of a recipe program and values of respective modules as a reference for calculation of rewards is not limited to the method described above, and may be other various methods for calculating these values. For example, a value of a recipe program may be calculated according to deliciousness of a dish.

### «Others»

A dish to be made in reference to a recipe program is not limited to food completed using a combination of various ingredients, such as food offered at a restaurant. A confection may be made or a drink such as alcohol and coffee may be made in reference to a recipe program. Note that examples of ingredients include not only vegetable ingredients such as vegetables and fruits and animal ingredients such as meat and fish, but also processed ingredients, seasoning, and drinks such as water and alcohol.

It is assumed that operations of the cooking robot 3 are divided into respective units of the cooking step, the action, the recognition operation, and the control operation. However, the respective units may be further divided into smaller units included in cooking, and a module may be prepared for each of these units.

### Program

The series of processes described above may be executed by either hardware or software. In a case where the series of processes are executed by software, a program constituting the software is installed in a computer incorporated in dedicated hardware, a general-purpose personal computer, or the like.

The program to be installed is recorded in a removable medium including an optical disk (e.g., CD-ROM (Compact Disc-Read Only Memory), DVD (Digital Versatile Disc)), a semiconductor memory, or the like, and provided in this form. Moreover, the program may be provided via a wired or wireless transfer medium, such as a local area network, the Internet, and digital broadcasting.

The program to be executed by a computer may be a program where processes are performed in time series in the order described in the present description, or may be a program where processes are performed in parallel or at a necessary timing such as an occasion of a call.

Note that the system in the present description refers to a set of multiple constituent elements (e.g., devices, modules (parts)). In this case, whether or not all constituent elements are contained in the same housing does not matter. Accordingly, multiple devices contained in different housings and connected via a network and one device containing multiple modules in one housing are both systems.

Advantageous effects to be offered are not limited to the advantageous effects described in the present description presented only by way of example. In addition, other advantageous effects may be offered.

Embodiments of the present technology are not limited to the embodiments described above, and may be modified in various manners without departing from the subject matters of the present technology.

For example, the present technology may have a configuration of cloud computing where one function is shared by multiple devices via a network and processed in cooperation with each other.

Moreover, the respective steps described in the above flowcharts may be executed by one device or may be shared and executed by multiple devices.

Furthermore, in a case of one step including multiple processes, the multiple processes included in the one step may be executed by one device or may be shared and executed by multiple devices.

### Combination Examples of Configurations

The present technology may also have the following configurations.

(1)

An information processing device including:

an acquisition unit that acquires a recipe program generated by combining, according to a dish, program modules prepared for each of cooking steps or for each unit of operations included in each of the cooking steps; and

a providing unit that provides the recipe program to a control device that controls cooking performed by a cooking robot.

(2)

The information processing device according to (1) described above, in which the recipe program is generated with use of multiple cooking step modules that are the program modules associated with the multiple cooking steps taken to complete the dish.

(3)

The information processing device according to (2) described above, in which each of the cooking step modules is generated with use of multiple action modules that are the program modules associated with multiple actions included in the corresponding cooking step and performed in a state in which a target is recognized.

(4)

The information processing device according to (3) described above, in which each of the action modules is generated with use of a recognition module that is a corresponding one of the program modules used for recognition of the target and a control module that is a corresponding one of the program modules associated with control of an operation performed by execution of the recognition module in a state in which the target is recognized.

(5)

The information processing device according to (4) described above, in which the recognition module is a corresponding one of the program modules used for recognition of an ingredient or a cooking device as the target.

(6)

The information processing device according to any one of (1) to (5) described above, further including: a management unit that manages the recipe program in association with a list of configurations of the cooking robot necessary for cooking based on the recipe program.

(7)

The information processing device according to any one of (1) to (6) described above, in which the providing unit provides the recipe program together with a program used for calculation of rewards given to respective developers of the recipe program and the program modules.

(8)

The information processing device according to (7) described above, in which the rewards are calculated on the basis of respective use statuses of the recipe program and the program modules.

(9)

An information processing method including: by an information processing device acquiring a recipe program generated by combining, according to a dish, program modules prepared for each of cooking steps or for each unit of operations included in each of the cooking steps; and providing the recipe program to a control device that controls cooking performed by a cooking robot.

(10)

An information processing terminal including: an acquisition unit that acquires any of program modules prepared for each of cooking steps or for each unit of operations included in each of the cooking steps, according to a dish, from a server that manages the program modules; and a generation unit that generates a recipe program to be provided to a control device that controls cooking of a cooking robot, by combining the program modules acquired from the server.

(11)

The information processing terminal according to (10) described above, in which the recipe program is generated with use of multiple cooking step modules that are the program modules associated with the multiple cooking steps to be taken to complete the dish.

(12)

The information processing terminal according to (11) described above, in which each of the cooking step modules is generated with use of multiple action modules that are the program modules associated with multiple actions included in the corresponding cooking step and performed in a state in which a target is recognized.

(13)

The information processing terminal according to (12) described above, in which each of the action modules is generated with use of a recognition module that is a corresponding one of the program modules used for recognition of the target and a control module that is a corresponding one of the program modules associated with control of an operation performed by execution of the recognition module in a state in which the target is recognized.

(14)

The information processing terminal according to (13) described above, in which the recognition module is a corresponding one of the program modules used for recognition of an ingredient or a cooking device as the target.

(15)

An information processing method including: by an information processing terminal acquiring any of program modules prepared for each of cooking steps or for each unit of operations included in each of the cooking steps, according to a dish, from a server that manages the program modules; and generating a recipe program to be provided to a control device that controls cooking performed by a cooking robot, by combining the program modules acquired from the server.

### REFERENCE SIGNS LIST

1: Application library distribution server
2: Developer terminal
3: Cooking robot
11: Network
21: Recipe program management server
22: Cooking step module management server
23: Action module management server
24: Recognition algorithm module management server
25: Control module management server
31: Developer site management server
32: Use number/period management server
33: Reward calculation server
151: Information processing unit
161: Module acquisition unit
162: Module storage unit
163: Module providing unit
164: Recipe program acquisition unit
165: Recipe program storage unit
166: Recipe program providing unit
201: Information processing unit
211: Module acquisition unit
212: Recipe program generation unit
213: Recipe program disclosure unit
301: Control device
431: Command generation unit
451: Recipe program acquisition unit
452: Robot state recognition unit
453: Control unit
454: Command output unit

1. An information processing device comprising:
an acquisition unit that acquires a recipe program generated by combining, according to a dish, program modules prepared for each of cooking steps or for each unit of operations included in each of the cooking steps; and
a providing unit that provides the recipe program to a control device that controls cooking performed by a cooking robot.

2. The information processing device according to claim 1, wherein the recipe program is generated with use of multiple cooking step modules that are the program modules associated with the multiple cooking steps taken to complete the dish.

3. The information processing device according to claim 2, wherein each of the cooking step modules is generated with use of multiple action modules that are the program modules associated with multiple actions included in the corresponding cooking step and performed in a state in which a target is recognized.

4. The information processing device according to claim 3, wherein each of the action modules is generated with use of a recognition module that is a corresponding one of the program modules used for recognition of the target and a control module that is a corresponding one of the program modules associated with control of an operation performed by execution of the recognition module in a state in which the target is recognized.

5. The information processing device according to claim 4, wherein the recognition module is a corresponding one of the program modules used for recognition of an ingredient or a cooking device as the target.

6. The information processing device according to claim 1, further comprising:
a management unit that manages the recipe program in association with a list of configurations of the cooking robot necessary for cooking based on the recipe program.

7. The information processing device according to claim 1, wherein the providing unit provides the recipe program together with a program used for calculation of rewards given to respective developers of the recipe program and the program modules.

8. The information processing device according to claim 7, wherein the rewards are calculated on a basis of respective use statuses of the recipe program and the program modules.

9. An information processing method comprising:
by an information processing device
acquiring a recipe program generated by combining, according to a dish, program modules prepared for each of cooking steps or for each unit of operations included in each of the cooking steps; and
providing the recipe program to a control device that controls cooking performed by a cooking robot.

10. An information processing terminal comprising:
an acquisition unit that acquires any of program modules prepared for each of cooking steps or for each unit of operations included in each of the cooking steps, according to a dish, from a server that manages the program modules; and
a generation unit that generates a recipe program to be provided to a control device that controls cooking of a cooking robot, by combining the program modules acquired from the server.

11. The information processing terminal according to claim 10, wherein the recipe program is generated with use of multiple cooking step modules that are the program modules associated with the multiple cooking steps to be taken to complete the dish.

12. The information processing terminal according to claim 11, wherein each of the cooking step modules is generated with use of multiple action modules that are the program modules associated with multiple actions included in the corresponding cooking step and performed in a state in which a target is recognized.

13. The information processing terminal according to claim 12, wherein each of the action modules is generated with use of a recognition module that is a corresponding one of the program modules used for recognition of the target and a control module that is a corresponding one of the program modules associated with control of an operation performed by execution of the recognition module in a state in which the target is recognized.

14. The information processing terminal according to claim 13, wherein the recognition module is a corresponding one of the program modules used for recognition of an ingredient or a cooking device as the target.

15. An information processing method comprising:
by an information processing terminal acquiring any of program modules prepared for each of cooking steps or for each unit of operations included in each of the cooking steps, according to a dish, from a server that manages the program modules; and
generating a recipe program provided to a control device that controls cooking performed by a cooking robot, by combining the program modules acquired from the server.
